(19) United States
(12) Patent Application Publication
(10) Pub. No.: US 2019/0297198 A1
(43) Pub. Date: Sep. 26, 2019

(54) IMAGE PROCESSING APPARATUS AND PROGRAM

(71) Applicant: KONICA MINOLTA, INC., Tokyo (JP)

(72) Inventors: Eisaku OWADA, Toyokawa-shi (JP); Akito OTA, Toyokawa-shi (JP); Yu SONODA, Toyokawa-shi (JP)

(73) Assignee: KONICA MINOLTA, INC., Tokyo (JP)

(21) Appl. No.: 16/356,035

(22) Filed: Mar. 18, 2019

(30) Foreign Application Priority Data
Mar. 22, 2018 (JP) 2018-054106

(51) Int. Cl. H04N 1/00; H04N 1/32

(52) U.S. Cl. CPC H04N 1/00244; H04N 1/00933; H04N 1/00323; H04N 2201/0094; H04N 1/32053; H04N 1/00915; H04N 2201/0072; H04N 1/32539

(57) ABSTRACT

There is provided an image processing apparatus that transmits data relating to an internal component to a server via a network, and the image processing apparatus includes a hardware processor that: acquires the data relating to the internal component; judges whether or not it is a transmission timing at which the data acquired is to be transmitted to the server; confirms an operation state of another image processing apparatus connected to the network in a case where it is judged that it is the transmission timing; decides whether or not to transmit the data acquired to the server based on a confirmation result; and transmits the data acquired to the server in a case where it is decided to perform data transmission.

The entire disclosure of Japanese patent Application No. 2018-054106, filed on Mar. 22, 2018, is incorporated herein by reference in its entirety.

### BACKGROUND

### Technological Field

The present invention relates to an image processing apparatus and a program, and more particularly to a technique in which an image processing apparatus transmits data to a server.

### Description of the Related Art

Image processing apparatuses such as multifunction peripherals (MFPs) are installed around the world. In such an image processing apparatus, various components are mounted that operate during execution of a job. When a failure occurs in those components or their lifetime expire, it becomes impossible for the image processing apparatus to execute the job normally. For that reason, the image processing apparatus is equipped with various sensors and counters for monitoring operation states and the like of those components.

Conventionally, as a system for performing remote diagnosis of this kind of image processing apparatus, a system is known in which a plurality of image processing apparatuses and a central diagnosis apparatus are connected to each other via a central management apparatus, and the central diagnosis apparatus collects data transmitted from each of the plurality of image processing apparatuses via the central management apparatus and performs diagnosis (for example, JP H5-167764 A). In this conventional technique, each of the plurality of image processing apparatuses performs failure prediction by analyzing data obtained from the apparatus main body, and decides a transfer timing of data, based on a result of the failure prediction. The central management apparatus decides order of accepting diagnostic data in descending order of the diagnostic rank level, based on a result of the failure prediction in each image processing apparatus.

However, in the above-described conventional technique, when deciding the transfer timing of the data, each image processing apparatus decides the transfer timing without considering a situation of another image processing apparatus. For that reason, in the conventional technique, there is a possibility that the plurality of image processing apparatuses starts data transfer simultaneously. When the plurality of image processing apparatuses starts data transfer simultaneously, a load increases on a server side such as the central management apparatus, and there is a possibility that the system may go down, which is a problem.

### SUMMARY

The present invention has been made to solve the above problems, and it is an object to provide an image processing apparatus and a program capable of effectively reducing the load on the server.

To achieve the abovementioned object, according to an aspect of the present invention, there is provided an image processing apparatus that transmits data relating to an internal component to a server via a network, and the image processing apparatus reflecting one aspect of the present invention comprises a hardware processor that: acquires the data relating to the internal component; judges whether or not it is a transmission timing at which the data acquired is to be transmitted to the server; confirms an operation state of another image processing apparatus connected to the network in a case where it is judged that it is the transmission timing; decides whether or not to transmit the data acquired to the server based on a confirmation result; and transmits the data acquired to the server in a case where it is decided to perform data transmission.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a diagram illustrating a configuration example of a prediction system that predicts a failure or the like of an image processing apparatus;

FIG. 2 is a diagram illustrating a configuration example of the image processing apparatus;

FIG. 3 is a diagram illustrating an example of an internal structure in an apparatus main body of the image processing apparatus;

FIG. 4 is a diagram illustrating a hardware configuration for performing electrical control in the image processing apparatus;

FIG. 5 is a block diagram illustrating a functional configuration of a control unit;

FIG. 6 is a diagram illustrating an example of a hardware configuration and a functional configuration of a server;

FIG. 7 is a diagram illustrating an example of a failure prediction list;

FIG. 8 is a diagram illustrating an example of operation until a plurality of image processing apparatuses obtains a failure prediction list;

FIG. 9 is a diagram illustrating a basic operation example in a case where it is detected in the image processing apparatus that it is a transmission timing;

FIG. 10 is a diagram illustrating an operation example in which the image processing apparatus confirms an operation state of another image processing apparatus whose rank is higher than that of the image processing apparatus;

FIG. 11 is a diagram illustrating another operation example in which the image processing apparatus confirms the operation state of the other image processing apparatus whose rank is higher than that of the image processing apparatus;

FIG. 12 is a diagram illustrating an operation example in a case where a component rank of a component operating in the other image processing apparatus is lower;

FIG. 13 is a diagram illustrating an operation example in a case where there is a possibility that the component operating in the other image processing apparatus fails;

FIG. 14 is a diagram illustrating an operation example in which the image processing apparatus performs data transmission before execution of a job ends in the other image processing apparatus;

FIG. 15 is a flowchart illustrating an example of a main processing procedure performed in the image processing apparatus;

FIG. 16 is a flowchart illustrating an example of a detailed processing procedure of timing judgment processing;

FIG. 17 is a flowchart illustrating an example of a detailed processing procedure of operation confirmation processing; and

FIG. 18 is a flowchart illustrating an example of a detailed processing procedure of transmission permission judgment processing.

### DETAILED DESCRIPTION OF EMBODIMENTS

Hereinafter, one or more embodiments of the present invention will be described with reference to the drawings. However, the scope of the invention is not limited to the disclosed embodiments. Note that, in the embodiment described below, the same reference numerals are given to members that are common to each other, and duplicate descriptions thereof will be omitted.

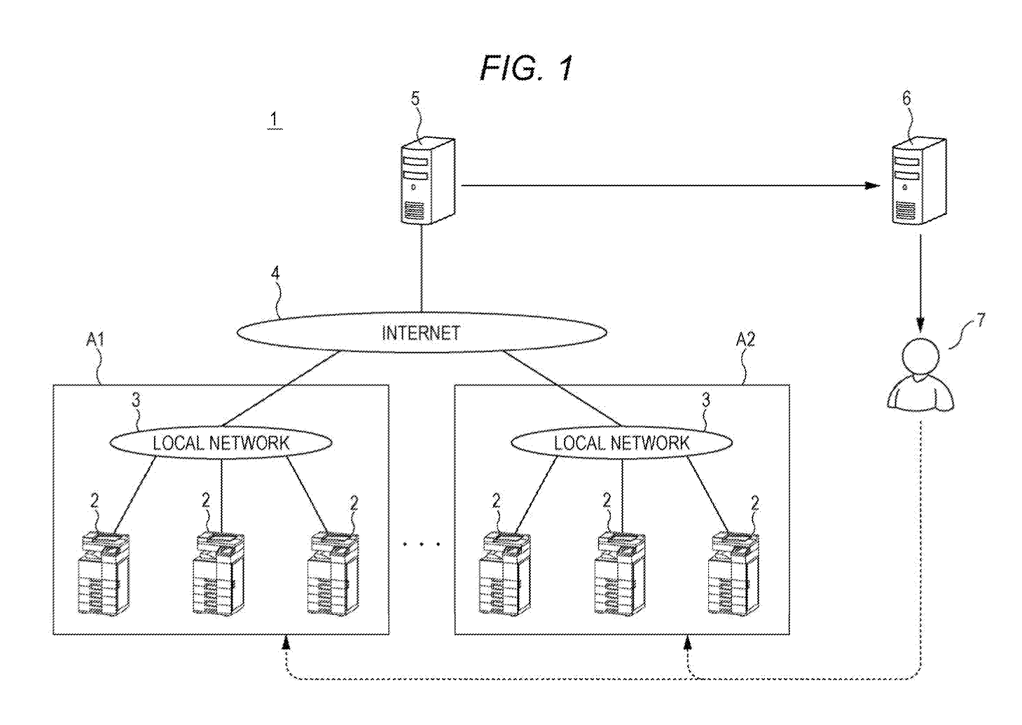

FIG. 1 is a diagram illustrating a configuration example of a prediction system 1 that predicts a failure or the like of an image processing apparatus 2 that is an embodiment of the present invention. The prediction system 1 includes a plurality of the image processing apparatuses 2 installed around the world, a server 5 that collects data from each of the plurality of image processing apparatuses 2 and performs a failure prediction, and a notification server 6 that notifies, based on a notification of the server 5, a maintenance inspector 7 to perform maintenance work of the image processing apparatuses 2 by e-mail or the like. Note that, in the present embodiment, a case is exemplified where the server 5 and the notification server 6 are different servers; however, these may be included in one server.

The server 5 can communicate with each of the plurality of image processing apparatuses 2 installed at a plurality of sites A1 and A2 around the world via, for example, the Internet 4. For example, a plurality of the image processing apparatuses 2 is installed at the site A1, and a plurality of the image processing apparatuses 2 is also installed at the site A2. Each of the plurality of image processing apparatuses 2 is connected to a local network 3 provided at each of the sites A1 and A2. The local network 3 is connected to the Internet 4. Each of the plurality of image processing apparatuses 2 can therefore communicate with the server 5 via, the local network 3 of each of the sites A1 and A2, and the Internet 4, and can transmit data for the failure prediction and the like to the server 5.

The image processing apparatus 2 is an apparatus including, for example, an MFP and has a plurality of functions such as a scan function, a print function, and a copy function, and accepts a function selection operation by a user and executes a job, based on a job execution instruction by the user. Examples of the job performed in the image processing apparatus 2 include a scan job, a print job, and a copy job. In a case where the image processing apparatus 2 has a FAX function, it is also possible to execute a job for transmitting and receiving FAX data. In a case where the image processing apparatus 2 includes a post-processing unit, it is also possible to perform post-processing such as stapling or punching during execution of the print job.

When executing the jobs described above, the image processing apparatus 2 operates various movable components mounted therein. If those components fail, it becomes impossible to execute the jobs in the image processing apparatus 2. In addition, those components are expendables consumed with execution of the jobs, and when a certain period of time has elapsed, or when the jobs are executed a predetermined number of times, their replacement time are reached. To make it possible to grasp such a replacement time of a component in the server 5, the image processing apparatus 2 acquires data for managing and monitoring various components mounted therein, and regularly transmits the data to the server 5 at predetermined time intervals. It is possible to set as appropriate a timing at which the image processing apparatus 2 regularly transmits the data to the server 5, and the timing is set in advance at predetermined date and time, for example, once a day, once a week, or once a month. However, as a frequency increases at which the image processing apparatus 2 transmits the data to the server 5, a load increases on the server 5. For that reason, the time interval at which the image processing apparatus 2 regularly transmits the data to the server 5, is preferably set to a relatively long interval such as once a month.

The image processing apparatus 2 not only transmits the data to the server 5 at predetermined time intervals, but also, transmits the data at, for example, a timing at which occurrence is detected of an abnormality such as a failure of a component, or a timing at which execution of a job has ended. Thus, the server 5 is enabled to grasp in real time changes in operation states of the movable components in each image processing apparatus 2.

Upon receiving the data transmitted from each image processing apparatus 2, the server 5 analyzes the data, thereby predicting in advance a failure, a lifetime, and the like of each component mounted in each image processing apparatus 2. In a case where there is a possibility that the failure occurs in a component mounted in the image processing apparatus 2 or in a case where the end of the lifetime of the component is close, the server 5 notifies the notification server 6 that it is the replacement time of the component. Upon receiving this notification, the notification server 6 notifies the maintenance inspector 7 being in the vicinity of an installation site of the image processing apparatus 2 that it is necessary to perform the maintenance work of the image processing apparatus 2. The maintenance inspector 7, visits the installation site of the image processing apparatus 2 and performs the maintenance work, whereby the image processing apparatus 2 can maintain a state in which the jobs can be executed.

In the prediction system 1 as described above, when detecting that it is the transmission timing such as the regular transmission timing, the timing at which the abnormality occurrence is detected, or the timing at which the execution of the job has ended, the image processing apparatus 2 starts processing of transmitting the data to the server 5. At this time, if the image processing apparatus 2 performs data transmission to the server simultaneously with the other image processing apparatus 2, the load increases on the server 5. To prevent this, the image processing apparatus 2 confirms an operation state of the other image processing apparatus 2, and does not perform data transmission simultaneously with the other image processing apparatus 2, thereby reducing the load on the server 5. Hereinafter, the image processing apparatus 2 will be described in detail.

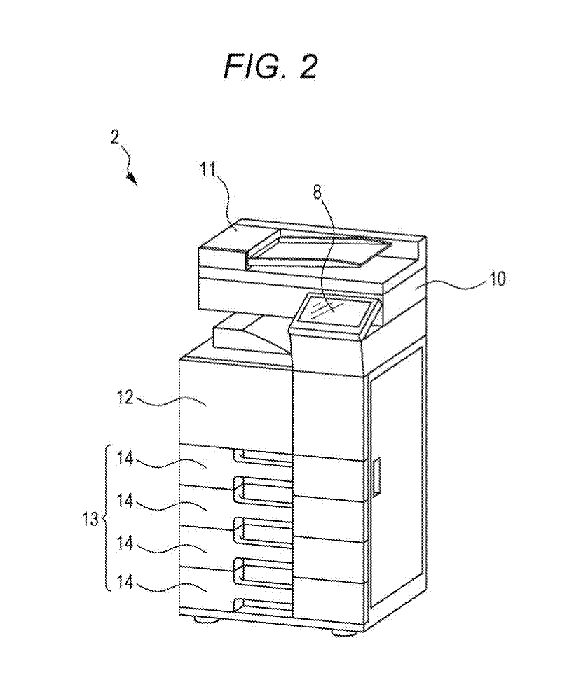

FIG. 2 is a diagram illustrating a configuration example of the image processing apparatus 2. The image processing apparatus 2 includes a scanner unit 10 and an automatic document feeder (hereinafter referred to as “ADF”) 11 in an upper portion of an apparatus main body. The scanner unit 10 and the ADF 11 perform operations in cooperation with each other when a scan job or a copy job is executed in the image processing apparatus 2. The scanner unit 10 optically reads an image of a document to generate image data. The ADF 11 is provided on the top of the scanner unit 10 and automatically conveys documents set by the user one by one to a document reading position of the scanner unit 10.

The image processing apparatus 2 includes a printer unit 12 and a sheet feeding unit 13 in a lower portion of the apparatus main body. The printer unit 12 and the sheet feeding unit 13 perform operations in cooperation with each other when a print job or a copy job is executed in the image processing apparatus 2. The sheet feeding unit 13 includes a plurality of sheet feeding cassettes 14, and sheets of different directions or sizes can be stocked in the respective sheet feeding cassettes 14. With an execution start of a print job or a copy job, the sheet feeding unit 13 feeds the sheets one by one from one of the sheet feeding cassettes 14 that stocks sheets designated by the user to the printer unit 12. The printer unit 12 performs print output by performing image formation on a sheet fed from the sheet feeding unit 13, based on image data input.

The image processing apparatus 2 further includes an operation panel 8 on the front side of the apparatus main body. The operation panel 8 serves as a user interface when the user uses the image processing apparatus 2.

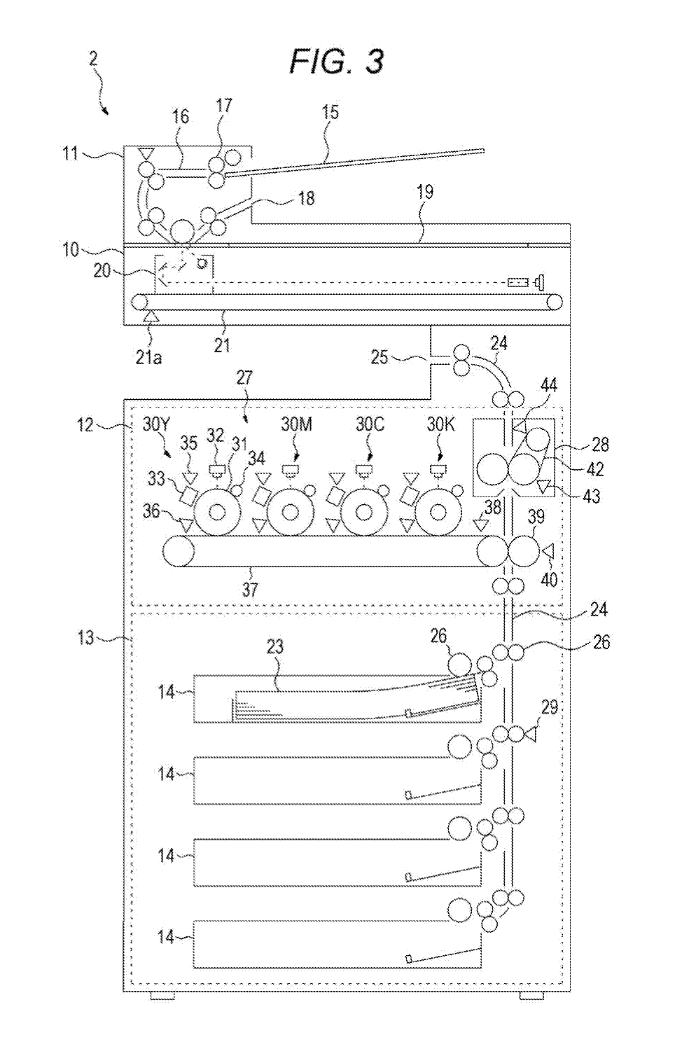

FIG. 3 is a diagram illustrating an example of an internal structure of the image processing apparatus 2. The scanner unit 10 includes a reading head 20, a drive belt 21, and a sensor 21a. The reading head 20 emits light to a document conveyed by the ADF 11 and guides reflected light from the document to a photoelectric conversion element. The reading head 20 is also capable of reading a document placed on a platen glass 19. That is, the reading head 20 is movable in a sub-scanning direction by the drive belt 21, and reads the image of the document by moving in the sub-scanning direction while reading the image of the document placed on the platen glass 19 in a main scanning direction. The sensor 21a is a sensor for measuring a sliding distance of the drive bell 21. For example, when the drive belt 21 is driven for a predetermined distance or more, its replacement time is reached. For that reason, to predict the replacement time of the drive belt 21, the sensor 21a measures the sliding distance of the drive belt 21 and monitors an operation state of the drive belt 21.

The ADF 11 includes a document tray 15 on which the documents are placed, a conveying path 16 through which the documents are conveyed, and conveying rollers 17, and the conveying rollers 17 convey the documents set on the document tray 15 one by one to the conveying path 16 and eject the documents from an ejection port 18. The ADF 11 is also provided with movable components such as the conveying rollers 17. For that reason, a sensor that monitors operation states of the movable components is provided also inside the ADF 11.

The sheet feeding unit 13 and the printer unit 12 are provided with a conveying path 24 through which a sheet 23 is conveyed. The conveying path 24 communicates with an ejection port 25 provided above the printer unit 12.

The sheet feeding unit 13 includes a plurality of rollers 26 that takes out and conveys the sheets 23 stocked in the sheet feeding cassettes 14 one by one along the conveying path 24, and conveys the sheets 23 by rotating the rollers 26. The sheet feeding unit 13 is provided with a sensor 29 for measuring a travel distance (the number of rotations) of the rollers 26. For example, when the rollers 26 are driven for a predetermined distance (the number of rotations) or more, their replacement times are reached. For that reason, to predict the replacement time of the rollers 26, the sensor 29 measures the travel distance (the number of rotations) of the rollers 26 and monitors operation states of the rollers 26.

The printer unit 12 includes an image forming section 27 and a fixing unit 28. The image forming section 27 has a configuration capable of forming a color image using toners of four colors of yellow (Y), magenta (M), cyan (C), and black (K), and includes image forming units 30Y, 30M, 30C, and 30K corresponding to the respective four colors.

The image forming unit 30Y includes a photosensitive drum 31, an exposing unit 32 that exposes a surface of the photosensitive drum 31 based on the image data to form an electrostatic latent image, a developing unit 33 that applies toner to the electrostatic latent image to form a toner image on the surface of the photosensitive drum 31, and a charging unit 34 that charges the surface of the photosensitive drum 31. A sensor 35 for measuring a remaining amount of toner is arranged in the vicinity of the developing unit 33, and a sensor 36 for measuring a sliding distance of the photosensitive drum 31 is arranged in the vicinity of the photosensitive drum 31. For example, when there is no remaining amount of toner in the developing unit 33, a replacement time is reached of a toner bottle, and when the sliding distance is a predetermined distance or more, a replacement time is reached of the photosensitive drum 31. For that reason, the sensors 35 and 36 are sensors provided to predict the replacement times of the toner bottle and the photosensitive drum. Note that, the other image forming units 30M, 30C, and 30K each have a confirmation similar to the configuration of the image forming unit 30Y.

The toner image formed on the photosensitive drum 31 is transferred to an intermediate transfer belt 37. The intermediate transfer belt 37 forms a color image on a surface of the belt by sequentially transferring the toner images of the four colors. When the sheet 23 fed from the sheet feeding unit 13 passes through a transfer roller 39, the color image formed on the intermediate transfer belt 37 is retransferred to the sheet 23. A sensor 38 for measuring a sliding distance of the intermediate transfer belt 37 is provided in the vicinity of the intermediate transfer belt 37. A sensor 40 for measuring a travel distance of the transfer roller 39 is provided in the vicinity of the transfer roller 39. These sensors 38 and 40 are sensors provided to monitor an operation state of the intermediate transfer belt 37 or the transfer roller 39 and predict their replacement times. The sheet 23 to which the color image is transferred by the transfer roller 39 is then conveyed to the fixing unit 28, and fixing processing is performed of the color image transferred to the surface.

The fixing unit 28 includes a fixing belt 42, and performs heat processing and pressure processing to the sheet 23 to which the color image is transferred, thereby fixing the color image on the sheet 23. The fixing unit 28 is provided with a sensor 43 for measuring a temperature of the fixing belt 42, and a sensor 44 for measuring a sliding distance of the fixing belt 42. That is, these sensors 43 and 44 are sensors provided to monitor operation states of components provided in the fixing unit 28 and predict their replacement times. The sheet 23 subjected to the fixing processing of the color image in the fixing unit 28 is then ejected from the ejection port 25.

As described above, the image processing apparatus 2 incorporates various sensors for monitoring the operation states of the components provided therein. Sensor measurement values measured by these sensors are included in the data regularly transmitted to the server 5 by the image processing apparatus 2.

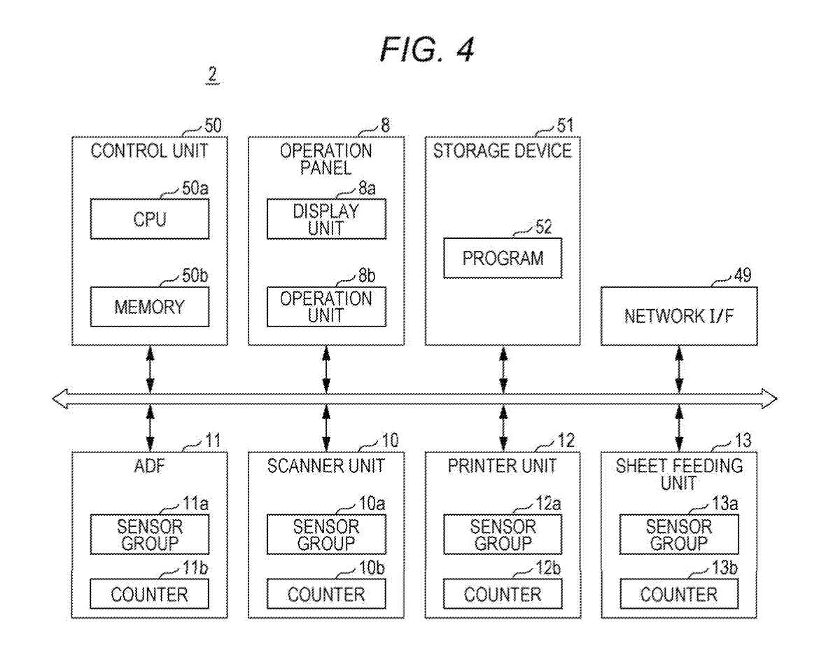

FIG. 4 is a diagram illustrating a hardware configuration for performing electrical control in the image processing apparatus 2. The image processing apparatus 2 includes a control unit 50, the operation panel 8, a storage device 51, a network interface 49, the ADF 11, the scanner unit 10, the printer unit 12, and the sheet feeding unit 13, and these units can mutually input and output data via a data bus.

The control unit 50 includes a CPU 50a and a memory 50b, and comprehensively controls operation of each unit in the image processing apparatus 2. The CPU 50a is a hardware processor capable of executing a program 52. For example, when the image processing apparatus 2 is powered on, the CPU 50a reads and executes the program 52 stored in the storage device 51, thereby functioning as various processing units as described later and controlling operation of each unit. The memory 50b is for temporarily storing data and the like to be used when the CPU 50a executes processing based on the program 52.

The operation panel 8 includes a display unit 8a and an operation unit 8b. The display unit 8a includes, for example, a color liquid crystal display, and displays various screens that can be operated by the user. The operation unit 8b includes, for example, a touch panel key arranged oil the screen of the display unit 8a, and accepts operation by the user.

The storage device 51 is a nonvolatile storage device including, for example, a hard disk drive (HDD). The program 52 described above is stored in the storage device 51. Various types of data as described later are also stored in the storage device 51.

The network interface 49 is for connecting the image processing apparatus 2 to the local network 3. The image processing apparatus 2 communicates with the server 5 via the network interface 49.

The ADF 11 includes a sensor group 11a and a counter 11b. The sensor group 11a includes at least one sensor that monitors the operation states of the movable components that operate when the ADF 11 performs document feeding. The sensor group 11a outputs to the control unit 50 a sensor measurement value of the operation states of the movable components measured based on a request from the control unit 50. The counter 11b counts and accumulates the number of documents fed by the ADF 11. The counter 11b outputs to the control unit 50 a count value of the number of documents fed by the ADF 11, based on a request from the control unit 50.

The scanner unit 10 includes a sensor group 10a and a counter 10b. The sensor group 10a includes at least one sensor that monitors the operation states of the movable components that operate when the scanner unit 10 performs document reading. For example, the sensor 21a described above is included in the sensor group 10a. The sensor group 10a outputs to the control unit 50 a sensor measurement value of the operation states of the movable components measured based on a request from the control unit 50. The counter 10b counts and accumulates the number of documents read by the scanner unit 10. The counter 10b outputs to the control unit 50 a count value of the number of documents read by the scanner unit 10, based on a request from the control unit 50.

The printer unit 12 includes a sensor group 12a and a counter 12b. The sensor group 12a includes a plurality of sensors that monitors the operation states of the movable components that operate when the printer unit 12 performs print output. For example, the sensors 35, 36, 38, 40, 43, and 44 described above are included in the sensor group 12a. The sensor group 12a outputs to the control unit 50 a sensor measurement value of the operation states of the movable components measured based on a request from the control unit 50. The counter 12b counts and accumulates the number of sheets printed out in the printer unit 12. The counter 12b outputs to the control unit 50 a count value of the number of sheets printed out by the printer unit 12, based on a request from the control unit 50.

The sheet feeding unit 13 includes a sensor group 13a and a counter 13b. The sensor group 13a includes at least one sensor that monitors the operation states of the movable components that operate when the sheet feeding unit 13 feeds one sheet. The sensor group 13a outputs to the control unit 50 a sensor measurement value of the operation states of the movable components measured based on a request from the control unit 50. The counter 13b counts and accumulates the number of sheets fed to the printer unit 12. The counter 13b may be provided for each of the sheet feeding cassettes 14. The counter 13b outputs to the control unit 50 a count value of the number of fed sheets, based on a request from the control unit 50.

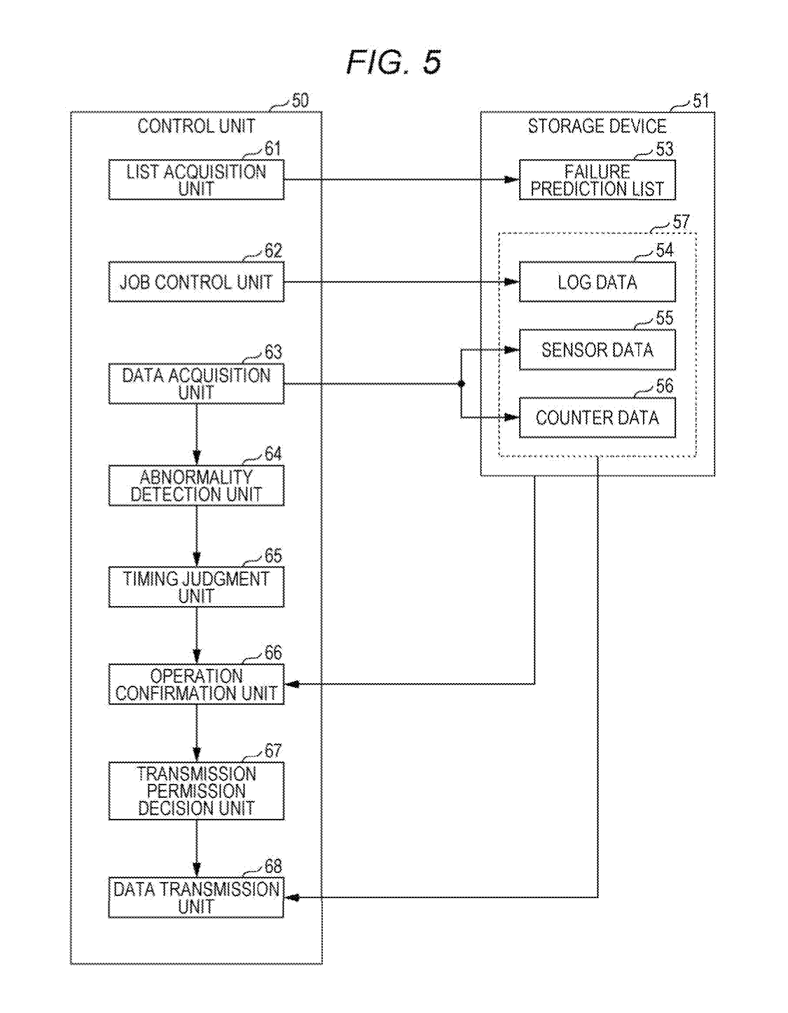

FIG. 5 is a block diagram illustrating an example of a functional configuration of the control unit 50. The CPU 50a executes the program 52 in the control unit 50, whereby the control unit 50 functions as a list acquisition unit 61, a job control unit 62, a data acquisition unit 63, an abnormality detection unit 64, a timing judgment unit 65, an operation confirmation unit 66, a transmission permission decision unit 67, and a data transmission unit 68. As illustrated in FIG. 5, the storage device 51 stores a failure prediction list 53, log data 54, sensor data 55, and counter data 56.

The list acquisition unit 61 is a processing unit that acquires the failure prediction list 53 in a case where time image processing apparatus 2 receives the failure prediction list 53 transmitted from the server 5, and stores the failure prediction list 53 in the storage device 51. The failure prediction list 53 is a list in which each of the plurality of image processing apparatuses 2 is ranked in order from the one whose possibility of failure is higher, or in order from the one whose replacement time of the component is closer, in the server 5. Details of the failure prediction list 53 will be described later.

The job control unit 62 controls execution of a job in the image processing apparatus 2. The job control unit 62 controls the operations of the ADF 11, the scanner unit 10, the printer unit 12, and the sheet feeding unit 13, thereby controlling execution of a job designated by the user. With the execution of the job designated by the user, the job control unit 62 records an execution history of the job in the log data 54. The log data 54 includes information such as execution date and time of the job, a type of the job, and presence or absence of occurrence of an abnormality such as an error.

The data acquisition unit 63 is a processing unit that acquires the sensor data 55 and the counter data 56 from the inside of the apparatus main body. That is, the data acquisition unit 63 makes a request for the sensor measurement value to each of the sensor groups 10a, 11a, 12a, and 13a, and acquires a plurality of sensor measurement values output from the respective sensor groups 10a, 11a, 12a, and 13a as the sensor data 55. The data acquisition unit 63 makes a request for the count value to each of the counters 10b, 11b, 12b, and 13b, and acquires a plurality of count values output from the respective counters 10b, 11b, 12b, and 13b as the counter data 56. The data acquisition unit 63 stores the sensor data 55 and the counter data 56 in the storage device 51.

For example, the data acquisition unit 63 acquires the sensor data 55 and the counter data 56 from the inside of the apparatus main body at regular time intervals of, for example, about several seconds or several minutes, and stores the data in tile storage device 51. The sensor data 55 and the counter data 56 stored in tile storage device 51 are therefore updated to the latest data reflecting the states of the components mounted inside the apparatus at constant time intervals. Note that, each of the log data 54, the sensor data 55, and the counter data 56 stored in the storage device 51 is one of elements constituting data 57 to be transmitted to the server 5.

The abnormality detection unit 64 functions each time the log data 54, the sensor data 55, and the counter data 56 stored in the storage device 51 are updated. The abnormality detection unit 64 analyzes each of the log data 54, the sensor data 55, and the counter data 56 updated in the storage device 51, thereby detecting the occurrence of the abnormality in the image processing apparatus 2. For example, in a case where an abnormality occurs during execution of a job, the abnormality is recorded in the log data 54. For that reason, the abnormality detection unit 64 analyzes the log data 54, thereby being able to detect the occurrence of the abnormality during execution of the job. In addition, when an abnormality occurs in each component mounted inside the apparatus, the sensor measurement value included in the sensor data 55 indicates an abnormal value. For that reason, tile abnormality detection unit 64 analyzes the sensor data 55, thereby also being able to detect the abnormality of each component mounted inside the apparatus. Further, when the replacement time is passed of each component mounted inside the apparatus, the count value included in the counter data 56 indicates a value equal to or greater than a predetermined value. For that reason, the abnormality detection unit 64 analyzes the counter data 56, thereby also being able to detect that it is in an abnormal state in which the replacement time has already been passed of each component mounted inside the apparatus.

The timing judgment unit 65 is a processing unit that judges whether or not it is a transmission timing at which data is to be transmitted to the server 5. In a case where an abnormality is detected by the abnormality detection unit 64, the timing judgment unit 65 judges that it is the transmission timing. In addition to this, in a case where execution of a job by the job control unit 62 has ended, or in a case where a time is reached at which the data is regularly transmitted to the server 5 (regular transmission timing), the timing judgment unit 65 judges that it is the transmission timing.

When it is judged by the timing judgment unit 65 that it is the transmission timing to the server 5, the control unit 50 causes the operation confirmation unit 66, the transmission permission decision unit 67, and the data transmission unit 68 to function.

In a case where it is judged by the timing judgment unit 65 that it is the transmission timing to the server 5, the operation confirmation unit 66 confirms an operation state of the other image processing apparatus 2 with which the image processing apparatus 2 can communicate. For example, the image processing apparatus 2 can communicate with the other image processing apparatus 2 connected to the same local network 3 as the image processing apparatus 2. For that reason, the operation confirmation unit 66 confirms the operation state of the other image processing apparatus 2 connected to the same local network 3 as the image processing apparatus 2.

For example, the operation confirmation unit 66 transmits a request for operation confirmation to the other image processing apparatus 2 connected to the same local network 3, and analyzes an answer received from the other image processing apparatus 2, thereby confirming the operation state of the other image processing apparatus 2. The operation confirmation unit 66 determines whether the other image processing apparatus 2 is in an ON state or an OFF state. For example, in a case where a job is being executed in the other image processing apparatus 2 and the internal movable components are in states of being operated, the operation confirmation unit 66 determines that the other image processing apparatus 2 is in the ON state. In addition, in a case where the other image processing apparatus 2 is in a state of performing data transmission to the server 5, the operation confirmation unit 66 determines that the other image processing apparatus 2 is in the ON state. On the other hand, if the internal movable components are not in states of being operated in the other image processing apparatus 2 and also the data transmission to the server 5 is not performed, the operation confirmation unit 66 determines that the other image processing apparatus 2 is in the OFF state.

The operation confirmation unit 66 may confirm operation states of all the other image processing apparatuses 2 connected to the same local network 3 as the image processing apparatus 2. However, in a case where a large number of image processing apparatuses 2 are connected to the same local network 3, it takes a lot of time to confirm the operation states of all the other image processing apparatuses 2. The operation confirmation unit 66 in the present embodiment therefore reads the failure prediction list 53 from the storage device 51, and narrows down the other image processing apparatus 2 to which operation confirmation is performed, based on the failure prediction list 53. That is, the operation confirmation unit 66 refers to the failure prediction list 53, thereby specifying as an operation confirmation target the other image processing apparatus 2 whose operation state is to be confirmed from among a plurality of the other image processing apparatuses 2 with which the image processing apparatus 2 can communicate. Specifically, the operation confirmation unit 66 refers to the failure prediction list 53, thereby specifying as the operation confirmation target at least the other image processing apparatus 2 whose rank is higher than that of the image processing apparatus 2. As described above, the failure prediction list 53 is a list in which the plurality of image processing apparatuses 2 is ranked in order from the one whose possibility of failure is higher, or in order from the one whose replacement time of the component is closer. For that reason, the operation confirmation unit 66 specifies as the operation confirmation target the other image processing apparatus 2 whose possibility of failure is higher than that of the image processing apparatus 2, or the other image processing apparatus 2 whose replacement time of the component is closer than that of the image processing apparatus 2. Note that, the operation continuation unit 66 may specify as the operation confirmation target not only an apparatus whose rank is higher than that of the image processing apparatus 2, but also an apparatus whose rank is the same as that of the image processing apparatus 2. The operation confirmation unit 66 confirms the operation state of the other image processing apparatus 2 specified as the operation confirmation target, and determines whether the other image processing apparatus 2 is in the ON state or the OFF state.

The transmission permission decision unit 67 is a processing unit that decides whether or not to transmit the data 57 to the server 5. In a case where it is judged that it is the transmission timing due to detection of the occurrence of the abnormality, the transmission permission decision unit 67 decides to transmit the data 57 to the server 5 regardless of the confirmation result of the operation state by the operation confirmation unit 66. That is, if an abnormality has occurred in the image processing apparatus 2, it is necessary to promptly transmit the data 57 to the server 5, so that the transmission permission decision unit 67 permits transmission of the data 57 to the server 5.

On the other hand, if the image processing apparatus 2 is in a state in which no abnormality has occurred, since urgency is low, the transmission permission decision unit 67 decides whether or not to transmit the data 57 to the server 5, based on the confirmation result of the operation state of the other image processing apparatus 2 by the operation confirmation unit 66. Specifically, in a case where it is determined that all the apparatuses among the other image processing apparatuses 2 specified as the operation confirmation targets are not in the ON state but in the OFF state, the transmission permission decision unit 67 decides to transmit the data 57 to the server 5 at the current transmission timing. That is, if all the other image processing apparatuses 2 are in the OFF state, there is a low possibility that data transmission is performed from the other image processing apparatuses 2 to the server 5, so that the transmission permission decision unit 67 decides that the image processing apparatus 2 performs data transmission to the server 5.

On the other hand, in a case where it is determined that at least one of the other image processing apparatuses 2 specified as the operation confirmation targets is in the ON state, the transmission permission decision unit 67 decides not to transmit the data 57 to the server 5 at the current transmission timing. That is, if at least one of the other image processing apparatuses 2 is in the ON state, when the image processing apparatus 2 starts data transmission, there is a possibility that data transmission is performed simultaneously with the other image processing apparatus 2. To avoid this, if at least one of the other image processing apparatuses 2 is in the ON state, the transmission permission decision unit 67 decides not to perform data transmission to the server 5 from the image processing apparatus 2. Thus, it can be prevented that the plurality of image processing apparatuses 2 simultaneously performs data transmission to the server 5.

On the other hand, even if the other image processing apparatus 2 is executing a job, it may be possible to complete the data transmission to the server 5 from the image processing apparatus 2 before the execution of the job ends. For that reason, in a case where it is determined by the operation confirmation unit 66 that at least one of the other image processing apparatuses 2 is in the ON state, the transmission permission decision unit 67 may judge whether a job is being executed in the at least one of the other image processing apparatuses 2, and if the job is being executed, determine whether or not it is possible to complete data transmission from the image processing apparatus 2 before the execution of the job ends. In a case where it is possible to complete the data transmission from the image processing apparatus 2 before the execution of the job ends in the at least one of the other image processing apparatuses 2, the transmission permission decision unit 67 may decide to perform data transmission to the server 5.

In a case where it is decided by the transmission permission decision unit 67 not to perform data transmission at the current transmission tuning, the timing judgment unit 65 decides the next transmission timing. The next transmission tuning in this case is decided as a timing that comes earlier than the next transmission timing for performing regular transmission. For example, the timing judgment unit 65 decides as the next transmission timing a timing at which a predetermined time such as five minutes has elapsed after the current transmission timing. For that reason, in a case where data transmission to the server 5 is not performed at the current transmission timing, the image processing apparatus 2 is enabled to detect the next transmission timing relatively early and transmit the latest data 57 to the server 5.

The data transmission unit 68 is a processing unit that functions in a case where it is decided by the transmission permission decision unit 67 that data transmission is to be performed at the current transmission timing, and transmits the data 57 to the server 5. The data, transmission unit 68 reads the log data 54, the sensor data 55, and the counter data 56 stored in the storage device 51, and generates the data 57 to be transmitted to the server 5. The data transmission unit 68 transmits the data 57 to the server 5.

In a case where the occurrence of the abnormality is detected by the abnormality detection unit 64, the data transmission unit 68 may extract only data indicating the abnormality from the log data 54, the sensor data 55, and the counter data 56 to generate the data 57, and transmit the data 57 to the server 5.

As described above, when judging that it is the transmission timing to the server 5, the image processing apparatus 2 confirms the operation state of the other image processing apparatus 2 connected to the same local network 3, and decides whether or not to transmit the data 57 to the server 5, based on the operation state of the other image processing apparatus 2. For example, if the other image processing apparatus 2 is performing data transmission to the server 5, the image processing apparatus 2 does not perform data transmission at the current transmission timing. In addition, when the other image processing apparatus 2 is executing a job, the image processing apparatus 2 does not perform data transmission at the current transmission timing. This is because, if the other image processing apparatus 2 is executing a job, there is a possibility that the other image processing apparatus 2 starts data transmission with the execution end of the job, and a situation may occur in which the plurality of image processing apparatuses 2 simultaneously performs data transmission. Therefore, if at least one of the other image processing apparatuses 2 is in the ON state, the image processing apparatus 2 does not perform data transmission from the image processing apparatus 2 at the current transmission timing, whereby it is possible to avoid that the plurality of image processing, apparatuses 2 simultaneously performs data transmission to the server 5, and to suppress that data transmission concentrates in the server 5 at a time.

When performing operation confirmation, as described above, the image processing apparatus 2 refers to the failure prediction list 53 and confirms the operation state of the other image processing apparatus 2 whose rank is higher than that of the image processing apparatus 2, whereby it is possible to prioritize data transmission to the server 5 to the other image processing apparatus 2 whose rank is higher than that of the image processing apparatus 2.

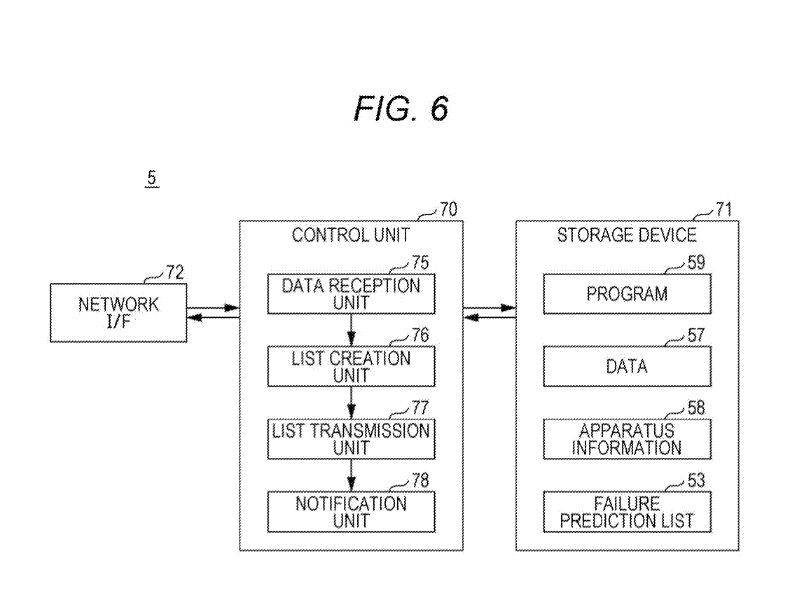

FIG. 6 is a diagram illustrating an example of a hardware configuration and a functional configuration of the server 5. The server 5 includes a control unit 70, a storage device 71, and a network interface 72 as its hardware configuration. The control unit 70 includes a CPU and a memory (not illustrated). The storage device 71 is a nonvolatile storage device including, for example, a hard disk drive (HDD), and stores a program 59, the data 57, apparatus information 58, and the failure prediction list 53. The apparatus information 58 is, for example, information in which the plurality of image processing apparatuses 2 managed by the server 5 is registered in advance, and includes information relating to a site where each image processing apparatus 2 is installed, and information relating to the local network 3 to which each image processing apparatus 2 is connected. For that reason, referring to the apparatus information 58, it is possible to specify all of the plurality of image processing apparatuses 2 connected to the same local network 3. The network interface 72 is for connecting the server 5 to a network including the Internet 4, and communicating with the image processing apparatus 2 and the notification server 6.

The CPU provided in the control unit 70 is a hardware processor capable of executing the program 59. The CPU executes the program 59, whereby the control unit 70 functions as a data reception unit 75, a list creation unit 76, a list transmission unit 77, and a notification unit 78.

The data reception unit 75 receives the data 57 transmitted from the image processing apparatus 2 via the network interface 72. Upon receiving the data 57 transmitted from the image processing apparatus 2, the data reception unit 75 stores the data 57 in the storage device 71. The data 57 is transmitted to the server 5 from each of the plurality of image processing apparatuses 2. For that reason, in the storage device 71, the latest data 57 is stored transmitted from each of the plurality of image processing apparatuses 2.

The list creation unit 76 functions in a case where the data reception unit 75 receives the data 57. The list creation unit 76 reads the latest data 57 stored in the storage device 71, and based on the data 57, predicts in advance a failure, a lifetime, and the like of each component mounted in each image processing apparatus 2. The list creation unit 76 ranks each of the plurality of image processing apparatuses 2 in order from the one whose possibility of failure is higher, or in order from the one Whose replacement time of the component is closer, and creates the failure prediction list 53. In addition to determining the possibility of failure of the component and a degree of arrival at the replacement time of the component, the list creation unit 76 may judge the number of times of abnormality occurrence of the component in each image processing apparatus 2, based on the log data 54 included in the data 57, for example, and rank each image processing apparatus 2 depending on the number of times of abnormality occurrence.

The list creation unit 76 may create one failure prediction list 53 in which the plurality of image processing apparatuses 2 installed at sites around the world is collectively ranked. However, it takes time to rank all of the plurality of image processing apparatuses 2 installed around the world. For that reason, it is preferable that the list creation unit 76 refers to the apparatus information 58, thereby specifying the plurality of image processing apparatuses 2 installed at the same site or the plurality of image processing apparatuses 2 connected to the same local network 3, and ranking the plurality of image processing apparatuses 2 for each site or each local network 3. Ranking is performed for each site or for each local network 3, whereby there is an advantage that the failure prediction list 53 can be efficiently created. In this case, the failure prediction list 53 is generated for each site or for each local network 3, and is stored in the storage device 71.

For example, in a case where the data reception unit 75 receives the data 57 transmitted from the image processing apparatus 2 installed at the site A1, the list creation unit 76 extracts only the data 57 of the plurality of image processing apparatuses 2 installed at the site A1 from the data 57 stored in the storage device 71, and analyzes the data 57 extracted, thereby ranking the plurality of image processing apparatuses 2 installed at the site A1. In this case, if there is no change in the data 57 of the plurality of image processing apparatuses 2 installed at the other site A2, there is no need to rank time plurality of image processing apparatuses 2 installed at the site A2, so that the processing burden can be reduced in the server 5.

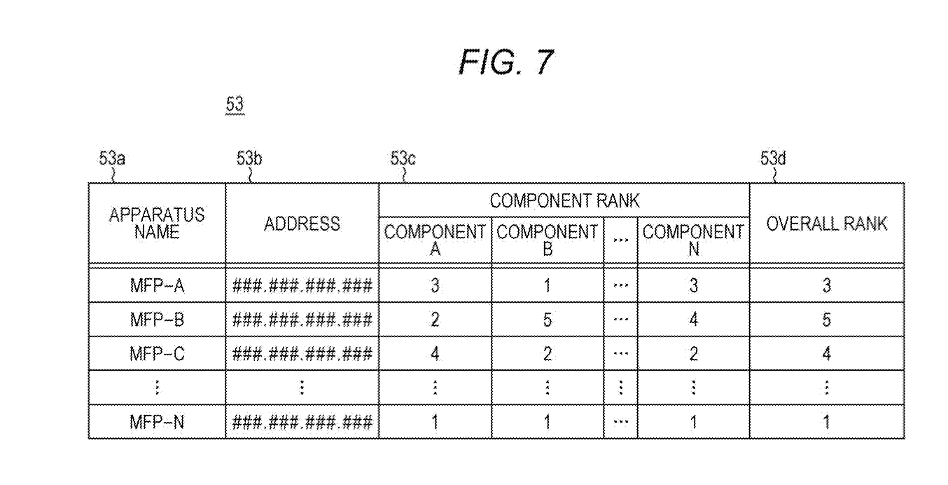

FIG. 7 is a diagram illustrating an example of the failure prediction list 53. The failure prediction list 53 includes an apparatus name 53a, an address 53b, a component rank 53c, and an overall rank 53d of each of the plurality of image processing apparatuses 2 ranked. For example, the apparatus name 53a is identification information capable of identifying each of the plurality of image processing apparatuses 2. The address 53b is an address for communicating with each of the plurality of image processing apparatuses 2. The component rank 53c is a rank indicating ease of failure of an individual component mounted in each image processing apparatus 2, and indicates that the component has a higher possibility of failure, or the replacement time of the component is closer, as a numerical value of the rank is greater, for example. Since a plurality of components is mounted in the image processing apparatus 2, the component rank 53c is information in which the rank of each component is individually defined. The overall rank 53d is a rank indicating whether or not there is a high possibility that any of the components fails in the image processing apparatus 2, and is a rank decided by comprehensively evaluating the component rank 53c.

Based on the data 57 acquired from each image processing apparatus 2, the list creation unit 76 grasps a state of the individual component and decides its rank, and records the rank decided in the component rank 53c. For example, in a case where it is found that voltage values vary when the charging unit 34 for charging the surface of the photosensitive drum 31 charges the photosensitive drum 31, in the data 57 acquired from the image processing apparatus 2, the list creation unit 76 determines that there is a high possibility that the charging unit 34 fails, and sets the component rank 53c corresponding to the charging unit 34 higher. For example, in a case where a print count value exceeds a predetermined value in the data 57 acquired from the image processing apparatus 2, the list creation unit 76 determines that the replacement time of the photosensitive drum 31 or the intermediate transfer belt 37 is close, and sets the component rank 53c corresponding to the photosensitive drum 31 or the intermediate transfer belt 37 higher. As described above, the list creation unit 76 decides the rank of each component depending on the degree of arrival at the replacement time of each component, for example, and records the rank in the component rank 53c.

The list creation unit 76 may set the component rank 53c of the component higher as the number of times of abnormality occurrence of the component in the past increases. For example, depending on an installation environment of the image processing apparatus 2 or the like, a failure occurrence rate of a specific component may become high. For that reason, the component rank 53c is set depending on the number of times of abnormality occurrence of the component, whereby it becomes possible to set the rank suitable for the installation environment or the like.

When deciding the overall rank 53d, the list creation unit 76 may obtain an average value of the component rank 53c of the components, for example, and decide the average value as the overall rank 53d. However, since the components mounted in the Image processing apparatus 2 include important components and components not so important, the overall rank 53d on which a degree of importance of the component is reflected is not obtained merely by calculating the average value of the component rank 53c. It is therefore preferable that the list creation unit 76 decides the overall rank 53d by performing weighting calculation of the component rank 53c of each component depending on the degree of importance of the component. For example, in a case where it becomes impossible to execute a print job in the image processing apparatus 2 when a certain component fails, if the degree of importance of the component is set higher in advance, the overall rank 53d of the image processing apparatus 2 largely varies depending on variation of the possibility of failure of the component. For that reason, the list creation unit 76 decides the overall rank 53d on which the degree of importance of each component is reflected, whereby the overall rank 53d recorded in the failure prediction list 53 becomes a rank indicating whether or not there is a high possibility that it becomes impossible to execute the job in the image processing apparatus 2.

The list creation unit 76 may confirm an operating state of each image processing apparatus 2, based on the log data 54 included in the data 57, and set the overall rank 53d lower of the image processing apparatus 2 whose frequency of use is less and of the image processing apparatus 2 not operating for a certain period of time or more.

When the failure prediction list 53 is created as described above, the list creation unit 76 stores the failure prediction list 53 in the storage device 71. In a case where the failure prediction list 53 is created for each site or for each local network 3 by the list creation unit 76, the storage device 71 stores a plurality of the failure prediction lists 53. The failure prediction lists 53 stored in the storage device 71 are updated each time the data 57 is received front the image processing apparatus 2.

In a case where the data 57 is received from one image processing apparatus 2 among the plurality of image processing apparatuses 2 included in the failure prediction list 53 in a state in which the failure prediction list 53 has already been created, the list creation unit 76 may change only the rank of the one image processing apparatus 2 to update the failure prediction list 53, based on the data 57. That is, since the rank of each image processing apparatus 2 is a rank decided depending on the state of the component inside the apparatus, there is no correlation with the rank of the other image processing apparatus 2. For that reason, in a case where the data 57 is received, the list creation unit 76 updates only the rank of the image processing apparatus 2 that has transmitted the data 57, thereby being enabled to efficiently update the failure prediction list 53.

The list creation unit 76 determines whether or not the data 57 received by the data reception unit 75 is data indicating an abnormal state or a warning state of the component. As a result of the determination, in a case where the data 57 received by the data reception unit 75 is the data indicating the abnormal state or the warning state of the component, the list creation unit 76 causes the notification unit 78 to function. Note that, the warning state is a state before the component fails to enter the abnormal state.

The list transmission unit 77 transmits the failure prediction list 53 to the image processing apparatus 2 each time the failure prediction list 53 is created or updated by the list creation unit 76. For example, in a case where the failure prediction list 53 for each site or for each local network 3 is created or updated by the list creation unit 76, the list transmission unit 77 refers to the apparatus information 58 and specifies the site or the local network 3 to be a transmission destination of the failure prediction list 53. The list transmission unit 77 transmits the failure prediction list 53 to the plurality of image processing apparatuses 2 provided in the site or the local network 3 specified. Thus, each image processing apparatus 2 is enabled to obtain the latest failure prediction list 53 from the server 5 each time the failure prediction list 53 is created or updated in the server 5.

The notification unit 78 is for notifying the notification server 6. That is, when it is determined by the list creation unit 76 that the component of the image processing apparatus 2 is in the abnormal state or the warning state, the notification unit 78 notifies the notification server 6 of the image processing apparatus 2 and the component in the abnormal state or the warning state. Thus, the notification server 6 can grasp a dispatch place of the maintenance inspector 7, the image processing apparatus 2 in the abnormal state or the warning state, and the component to be subjected to the maintenance work, and is enabled to notify the maintenance inspector 7 to perform the maintenance work.

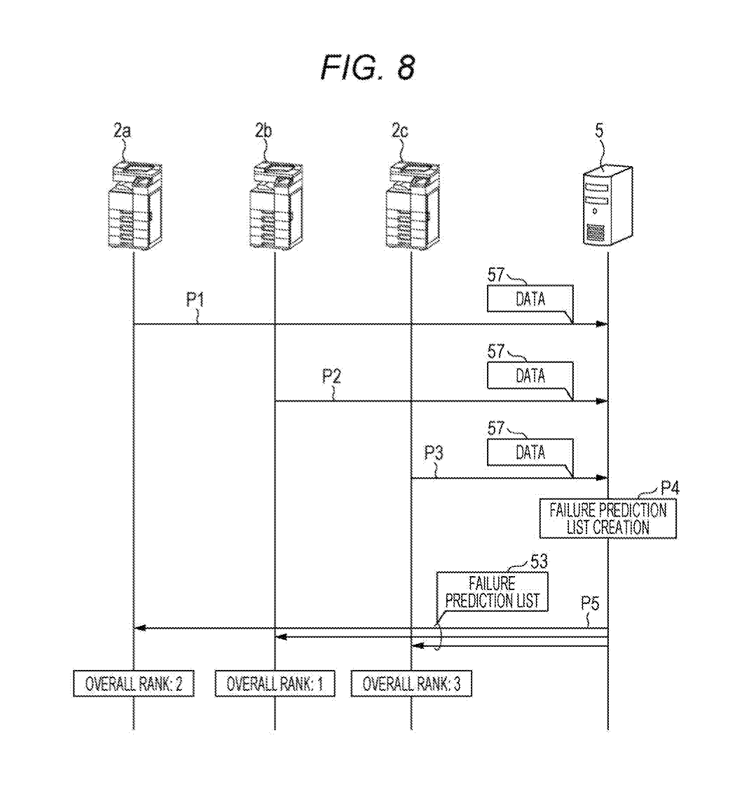

Next, operation will be described of the prediction system 1 having the above-described configuration. FIG. 8 is a diagram illustrating an example of the operation until a plurality of image processing apparatuses 2a, 2b, and 2c acquires the failure prediction list 53. Note that, in FIG. 8, a case is exemplified where the plurality of image processing apparatuses 2a, 2b, and 2c is connected to the same local network 3, and this also applies to other operation examples described below.

First, as illustrated in FIG. 8, upon detecting that the transmission timing is reached at which the regular transmission is performed to the server 5, for example, the image processing apparatus 2a acquires the data 57 to be transmitted from the apparatus main body to the server 5, and transmits the data 57 to the server 5 (process P1). Thereafter, upon detecting that the transmission timing is reached at which the regular transmission is performed to the server 5, the image processing apparatus 2b acquires the data 57 to be transmitted from the apparatus main body to the server 5, and transmits the data 57 to the server 5 (process P2). Thereafter, upon detecting that the transmission timing is reached at which the regular transmission is performed to the server 5, the image processing apparatus 2c acquires the data 57 to be transmitted from the apparatus main body to the server 5, and transmits the data 57 to the server 5 (process P3). Upon receiving the data 57 from each of the plurality of image processing apparatuses 2a, 2b, and 2c, the server 5 generates the failure prediction list 53 in which the plurality of image processing apparatuses 2a, 2b, and 2c is ranked (process P4). Then, the server 5 transmits the failure prediction list 53 to each of the plurality of image processing apparatuses 2a, 2b, and 2c (process P5). Upon receiving the failure prediction list 53 from the server 5, each of the image processing apparatuses 2a, 2b, and 2c stores and manages the failure prediction list 53 in the storage device 51. Thus, each of the image processing apparatuses 2a, 2b, and 2c can grasp the rank of each of the image processing apparatuses 2a, 2b, and 2c in the failure prediction list 53. In the example of FIG. 8, the rank (overall rank) of the image processing apparatus 2b is the lowest and the rank is “1”. The rank of the image processing apparatus 2c is the highest and the rank is “3”. The image processing apparatus 2a is in the intermediate rank of the image processing apparatuses 2b and 2c, and the rank is “2”.

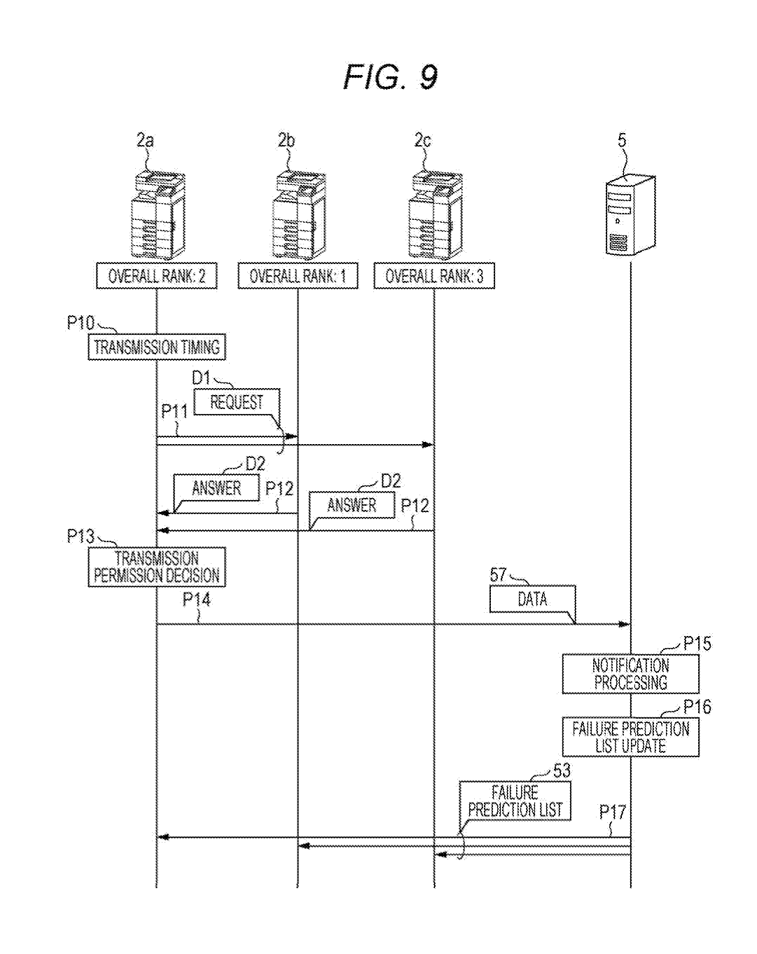

Next, FIG. 9 is a diagram illustrating an operation example in a case where it is detected in the image processing apparatus 2a that it is the transmission timing. When the ranks of the image processing apparatuses 2a, 2b, and 2c are respectively “2”, “1”, and “3” as described above, when it is detected by the image processing apparatus 2a that it is the transmission timing (process P10), the image processing apparatus 2a transmits a request D1 for confirming the operation state to the other image processing apparatuses 2b and 2c (process P11). Upon receiving the request D1, the image processing apparatuses 2b and 2c respectively transmit answers D2 indicating operation states of the image processing apparatuses 2b and 2c to the image processing apparatus 2a. The answers D2 each include information indicating the detailed operation state of a corresponding one of the image processing apparatuses 2b and 2c. For example, when the image processing apparatuses 2b and 2c each are executing a job, the answers D2 each include information indicating a type of the job, a setting of the job, an execution amount of the job, a current execution status, a predicted end time of the job, a component operating with execution of the job, and the like. Upon receiving the answers D2 from the other image processing apparatuses 2b and 2c, the image processing apparatus 2a judges whether or not the other image processing apparatuses 2b and 2c are in the ON state, based on the answers D2. Based on the judgment result, the image processing apparatus 2a decides whether or not data transmission to the server 5 is possible (process P13). At this time, if both of the other two image processing apparatuses 2b and 2c are in the OFF state, the image processing apparatus 2a decides to transmit the data 57 to the server 5 at the current transmission timing. Then, the image processing apparatus 2a transmits the data 57 to the server 5 (process P14).

Upon receiving the data 57 from the image processing apparatus 2a, the server 5 performs notification processing to the notification server 6 as necessary (process P15). Thus, processing for dispatching the maintenance inspector 7 is performed by the notification server 6. The server 5 updates the failure prediction list 53, based on the data 57 received from the image processing apparatus 2a (process P16), and transmits the failure prediction list 53 updated to each of the plurality of image processing apparatuses 2a, 2b, and 2c (process P17). Thus, each of the image processing apparatuses 2a, 2b, and 2c updates the failure prediction list 53 stored in each of the image processing apparatuses 2a, 2b, and 2c.

In the operation example illustrated in FIG. 9, the image processing apparatus 2a transmits the request D1 to all the image processing apparatuses 2b and 2c connected to the same local network 3. That is, since the image processing apparatus 2a transmits the request D1 to all the image processing apparatuses 2b and 2c without referring to the failure prediction list 53, the image processing apparatus 2a transmits the request D1 to the image processing apparatus 2b whose rank is lower than that of the image processing apparatus 2a. However, the image processing apparatus 2a may confirm only the operation state of the image processing apparatus 2c whose rank is higher than that of the image processing apparatus 2a and decide whether or not to perform data transmission.

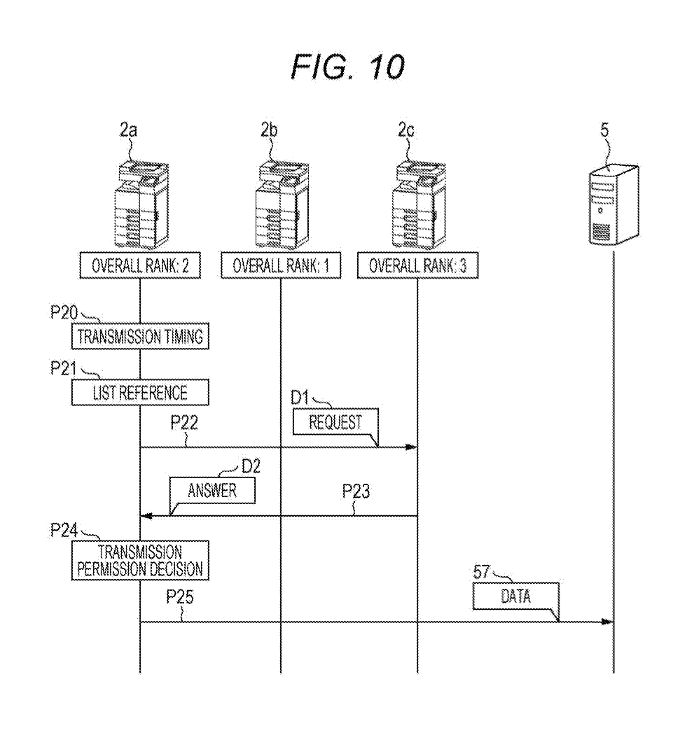

FIG. 10 is a diagram illustrating an operation example in which the image processing apparatus 2aconfirms the operation state of the image processing apparatus 2c whose rank is higher than that of the image processing apparatus 2a. When the ranks of the image processing apparatuses 2a, 2b, and 2c are respectively “2”, “1”, and “3” similarly to the above, when it is detected by the image processing apparatus 2a that it is the transmission timing (process P20), the image processing apparatus 2a first refers to the failure prediction list 53 (process P21), and specifies the image processing apparatus 2c whose overall rank 53d is higher than that of the image processing apparatus 2a in the failure prediction list 53. Then, the image processing apparatus 2a transmits the request D1 for confirming the operation state to the image processing apparatus 2c whose rank is higher than that of the image processing apparatus 2a (process P22). At this time, the image processing apparatus 2a does not transmit the request D1 to the image processing apparatus 2b whose rank is lower than that of the image processing apparatus 2a. The image processing apparatus 2a can therefore receive the answer D2 indicating the operation state from the image processing apparatus 2c whose rank is higher than that of the image processing apparatus 2a (process P23).

Upon receiving the answer D2, the image processing apparatus 2a decides whether or not to perform data transmission to the server 5, based on the operation state of the image processing apparatus 2c whose rank is higher than that of the image processing apparatus 2a (process P24). For example, when the image processing apparatus 2c is in the OFF state, the image processing apparatus 2a decides to transmit the data 57 to the server 5 at the current transmission timing. Then, the image processing apparatus 2a transmits the data 57 to the server 5 (process P25). Therefore, if the image processing apparatus 2c whose rank is higher than that of the image processing apparatus 2a is in the OFF state, the image processing apparatus 2a can promptly transmit the data 57 to the server 5 at the current transmission timing. At this time, since the image processing apparatus 2a does not perform data transmission simultaneously with other image processing apparatus 2c, the data transmission can be efficiently performed without burdening the server 5.

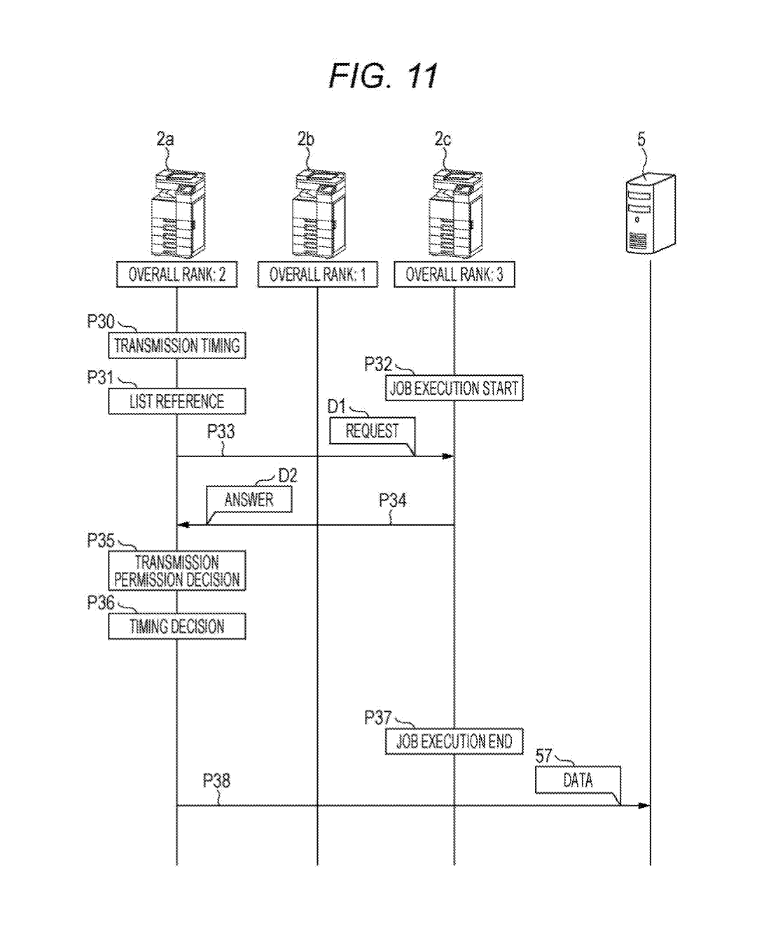

FIG. 11 is a diagram illustrating another operation example in which the image processing apparatus 2a confirms the operation state of the image processing apparatus 2c whose rank is higher than that of the image processing apparatus 2a. When the ranks of the image processing apparatuses 2a, 2b, and 2c are respectively “2”, “1”, and “3” similarly to the above, when it is detected by the image processing apparatus 2a that it is the transmission timing (process P30), time image processing apparatus 2a first refers to the failure prediction list 53, and specifies the image processing apparatus 2c whose overall rank 53d is higher than that of the image processing apparatus 2a in the failure prediction list 53 (process P31). When these processes are proceeding in the image processing apparatus 2a, execution of a job is started in the image processing apparatus 2c (process P32).

When the image processing apparatus 2a specifies the image processing apparatus 2c whose rank is higher than that of the image processing apparatus 2c as the operation confirmation target, the image processing apparatus 2a transmits the request D1 for confirming the operation state to the image processing apparatus 2c (process P33). At this time, the image processing apparatus 2c is executing the job. For that reason, the image processing apparatus 2c generates the answer D2 indicating that the job is being executed, and transmits the answer D2 to the image processing apparatus 2a (process P34).

Upon receiving the answer D2, the image processing apparatus 2a grasps the operation state of the image processing apparatus 2c, based on the answer D2, and decides whether or not to perform data transmission to the server 5 (process P35). At this time, since the image processing apparatus 2c is in the ON state, the image processing apparatus 2a decides not to perform the data transmission to the server 5 at the current transmission timing. Then, the image processing apparatus 2a decides the next transmission timing (process P36).

Thereafter, the execution of the job ends in the image processing apparatus 2c (process P37). Then, when the same process as described above is performed when the next transmission timing is reached, the image processing apparatus 2a grasps that the image processing apparatus 2c is in the OFF state, so that the data 57 is transmitted to the server 5 (process P38). That is, in a case where the other image processing apparatus 2c whose rank is higher than that of the image processing apparatus 2a is executing the job and operating the movable component when it is detected that it is the transmission timing, the image processing apparatus 2a performs the data transmission to the server 5 after the job being executed in the other image processing apparatus 2c ends. However, when the other image processing apparatus 2c performs data transmission to the server 5 after ending the job, it is preferable that after completion of the data transmission, the image processing apparatus 2a starts data transmission. Thus, it can be prevented that the plurality of image processing apparatuses 2 simultaneously performs data transmission to the server 5, so that the load can be reduced on the server 5.

Even when the job is being executed in the other image processing apparatus 2c whose rank is higher than that of the image processing apparatus 2a, if the component mounted in the image processing apparatus 2c does not enter the warning state or the abnormal state during the execution or at the end of the execution of the job, the image processing apparatus 2a may preferentially perform data transmission. For that reason, based on the answer D2 received from the other image processing apparatus 2c, the image processing apparatus 2a specifies a movable component operating during execution of the job, and determines whether or not the component rank 53c of the movable component is higher than a predetermined rank. As a result, in a case Where the component rank 53c is not higher than the predetermined rank, the image processing apparatus 2a may perform data transmission to the server 5.

For example, in a case where it is determined that the movable component is operating, based on the answer D2 from the other image processing apparatus 2c, the operation confirmation unit 66 specifies the component rank 53c of the movable component being operated in the other image processing apparatus 2c by referring to the failure prediction list 53, and determines whether or not the component rank 53c specified is higher than the predetermined rank. Since the fact that the component rank 53c is higher than the predetermined rank means that the component replacement time is close, there is a possibility that the component fails during the execution or at the end of the execution of the job. On the other hand, in a case where the component rank 53c is not higher than the predetermined rank, there is no possibility that the component fails during the execution or at the end of the execution of the job. For that reason, when it is judged by the operation confirmation unit 66 that the component rank 53c of the component operating, in the other image processing apparatus 2c is not higher than the predetermined rank, the transmission permission decision unit 67 decides to perform data transmission at the current transmission timing. In other words, in a case where the component rank 53c of the component operating in the other image processing apparatus 2c is not higher than the predetermined rank, the operation confirmation unit 66 judges that the other image processing apparatus 2c is in the OFF state.

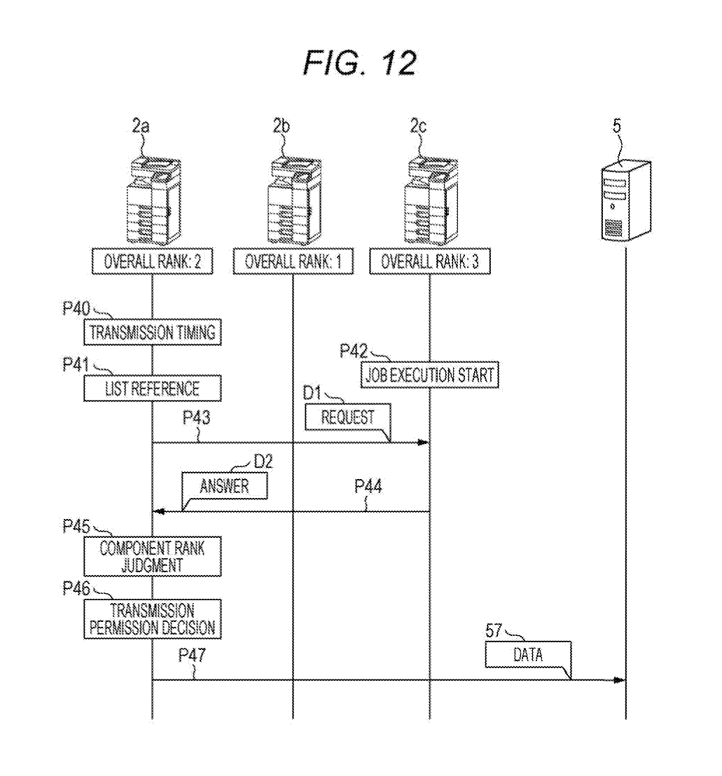

FIG. 12 is a diagram illustrating an operation example in a case where the component rank 53c of the component operating in the other image processing apparatus 2c is lower. When the ranks of the image processing apparatuses 2a, 2b, and 2c are respectively “2”, “1”, and “3” similarly to the above, when it is detected by the image processing apparatus 2a that it is the transmission timing (process P40), the image processing apparatus 2a first refers to the failure prediction list 53, and specifies the image processing apparatus 2c whose overall rank 53d is higher than that of the image processing apparatus 2a in the failure prediction list 53 (process P41). When these processes are proceeding in the image processing apparatus 2a, execution of a job is started in the image processing apparatus 2c (process P42).

When the image processing apparatus 2a specifies the image processing apparatus 2c whose rank is higher than that of the image processing apparatus 2c as the operation confirmation target, the image processing apparatus 2a transmits the request D1 for confirming the operation state to the image processing apparatus 2c (process P43). At this time, the image processing apparatus 2c is executing the job. For that reason, the image processing apparatus 2c generates the answer D2 indicating that the job is being executed, and transmits the answer D2 to the image processing apparatus 2a (process P44).

Upon receiving the answer D2, the image processing apparatus 2a grasps the operation state of the image processing apparatus 2c, based on the answer D2. When grasping that the image processing apparatus 2c is executing the job, the image processing apparatus 2a specifies a component operating in the image processing apparatus 2c and refers to the failure prediction list 53, thereby judging the component rank 53c of the component (process P45). That is, it is judged whether or not the component rank 53c is higher than the predetermined rank. As a result, when it is judged that the component rank 53c is not higher than the predetermined rank, the image processing apparatus 2a decides to transmit the data 57 to the server 5 (process P46). Thereafter, the image processing apparatus 2a transmits the data 57 to the server 5 (process P47). Titus, the image processing apparatus 2a is enabled to transmit the data 57 to the server 5 preferentially than the other image processing apparatus 2c whose rank is higher than that of the image processing apparatus 2a.

In a case where the component rank 53c of the component operating in the other image processing apparatus 2c is higher than the predetermined rank, the image processing apparatus 2a may further determine whether or not there is a possibility that the component fails during the operation or at the end of the operation of the component. For example, in a case where it is determined that the movable component is operating, based on the answer D2 from the other image processing apparatus 2c, the operation confirmation unit 66 specifies the component rank 53c of the movable component being operated in the other image processing apparatus 2c by referring to the failure prediction list 53, and determines whether or not the component rank 53c specified is higher than the predetermined rank. Since the fact that the component rank 53c is higher than the predetermined rank means that the component replacement time is close, there is a possibility that the component fails during the execution or at the end of the execution of the job. For that reason, the operation confirmation unit 66 refers to detailed information of the job included in the answer 132, and determines whether or not there is a high possibility that the component fails during the execution or at the end of the execution of the job.

For example, it is assumed that a component operates during execution of a print job, and there is a possibility that the component fails if 500 more sheets of print output is performed. If in this case, as a result of analyzing the answer D2, in a case where a print job being executed in the other image processing apparatus 2c is a job for performing 1000 sheets of print output, the operation confirmation unit 66 determines that there is a possibility that the component fails during the operation or at the end of the operation of the component. On the other hand, in a case where the print job being executed in the other image processing apparatus 2c is a job for performing 100 sheets of print output, the operation confirmation unit 66 determines that there is no possibility that the component fails during the operation or at the end of the operation of the component.

Based on the result of the determination as described above, the image processing apparatus 2a decides whether or not to transmit the data 57 to the server 5 at the current transmission timing. For example, when it is determined by the operation confirmation unit 66 that there is no possibility that the component operating in the other image processing apparatus 2c fails during the operation or at the end of the operation of the component, the transmission permission decision unit 67 decides to transmit the data 57 to the server 5 at the current transmission

On the other hand, when it is determined by the operation confirmation unit 66 that there is a possibility that the component operating in the other image processing apparatus 2c fails during the operation or at the end of the operation of the component, the transmission permission decision unit 67 decides not to transmit the data 57 to the server 5 at the current transmission timing In this case, it is preferable that the image processing apparatus 2a performs data transmission after the other image processing apparatus 2c completes data transmission to the server 5.

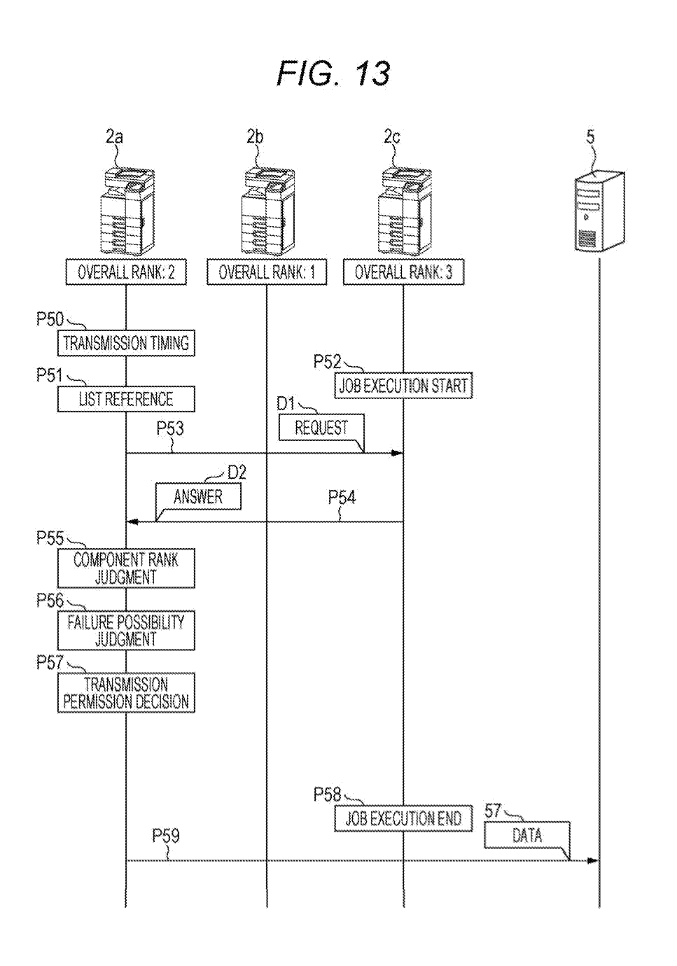

FIG. 13 is a diagram illustrating an operation example in a case Where there is a possibility that the component operating in the other image processing apparatus 2c fails. When the ranks of the image processing apparatuses 2a, 2b, and 2c are respectively “2”, “1”, and “3” similarly to the above, when it is detected by the image processing apparatus 2a that it is the transmission timing (process P50), the image processing apparatus 2a first refers to the failure prediction list 53, and specifies the image processing apparatus 2c whose overall rank 53d is higher than that of the image processing apparatus 2a in the failure prediction list 53 (process P51). When these processes are proceeding in the image processing apparatus 2a, execution of a job is started in the image processing apparatus 2c (process P52).

When the image processing apparatus 2a specifies the image processing apparatus 2c whose rank is higher than that of the image processing apparatus 2c as the operation confirmation target, the image processing apparatus 2a transmits the request D1 for confirming the operation state to the image processing apparatus 2c (process P53). At this time, the image processing apparatus 2c is executing the job. For that reason, the image processing apparatus 2c generates the answer D2 indicating that the job is being executed, and transmits the answer D2 to the image processing apparatus 2a (process P54).

Upon receiving the answer D2, the image processing apparatus 2a grasps the operation state of the image processing apparatus 2c, based on the answer D2. When grasping that the image processing apparatus 2c is executing the job, the image processing apparatus 2a specifies a component operating in the image processing apparatus 2c and refers to the failure prediction list 53, thereby judging the component rank 53c of the component (process P55). That is, it is judged whether or not the component rank 53c is higher than the predetermined rank. As a result, when it is judged that the component rank 53c is higher than the predetermined rank, the image processing apparatus 2a judges a possibility of failure of the component (process P56). That is, the image processing apparatus 2a analyzes the job being executed by the other image processing apparatus 2c, and judges whether or not there is a possibility that the component fails during the execution or at the end of the execution of the job. In a case where there is a possibility that the component fails, the image processing apparatus 2a decides not to transmit the data 57 to the server 5 at the current transmission timing (process P57). That is, to allow the other image processing apparatus 2c to start data transmission immediately when the component of the other image processing apparatus 2c fails, the image processing apparatus 2a does not perform data transmission of the image processing apparatus 2, and waits.

Thereafter, the image processing apparatus 2c ends the execution of the job (process P58), and then performs data transmission to the server 5. The image processing apparatus 2a waits until the data transmission is completed, and then transmits the data 57 of the image processing apparatus 2a to the server 5 (process P59). Also in this operation example, since the image processing apparatus 2a does not perform data transmission simultaneously with the other image processing apparatus 2c, it is possible to transmit the data 57 to the server 5 without increasing the load on the server 5.

Even in a case where there is a possibility that the component operating in the other image processing apparatus 2c fails at the end of the operation of the component, in a case where the job being executed in the other image processing apparatus 2c requires a long time, the image processing apparatus 2a can preferentially perform data transmission of the image processing apparatus 2a. For example, when there is a possibility that the component of the other image processing apparatus 2c fails due to 1000 more sheets of print output, and a print job for performing 1000 sheets of print output is executed in the other image processing apparatus 2c, the transmission permission decision unit 67 acquires the predicted end time of the job included, in the answer D2, and determines whether or not it is possible to complete data transmission to the server 5 before the execution of the job is completed. Then, on condition that the data transmission to the server 5 can be completed before the execution of the job is completed in the other image processing apparatus 2c, the transmission permission decision unit 67 decides to perform the data transmission to the server 5.

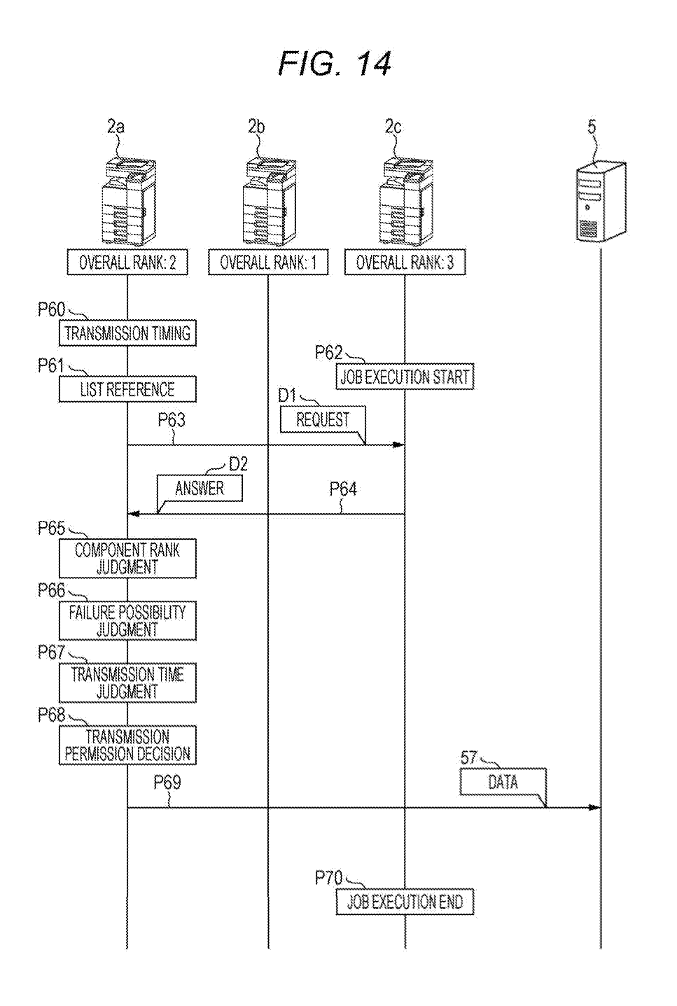

FIG. 14 is a diagram illustrating an operation example in which the image processing apparatus 2a performs data transmission before the execution of the job in the other image processing apparatus 2c ends. When the ranks of the image processing apparatuses 2a, 2b, and 2c are respectively “2”, “1”, and “3” similarly to the above, when it is detected by the image processing apparatus 2a that it is the transmission timing (process P60), the image processing apparatus 2a first refers to the failure prediction list 53, and specifies the image processing apparatus 2c whose overall rank 53d is higher than that of the image processing apparatus 2a in the failure prediction list 53 (process P61). When these processes are proceeding in the image processing apparatus 2a, execution of a job is started in the image processing apparatus 2c (process P62).

When the image processing apparatus 2a specifies the image processing apparatus 2c whose rank is higher than that of the image processing apparatus 2c as the operation confirmation target, the image processing apparatus 2a transmits the request D1 for confirming the operation state to the image processing apparatus 2c (process P63). At this time, the image processing apparatus 2c is executing the job. For that reason, the image processing apparatus 2c generates the answer D2 indicating that the job is being executed, and transmits the answer D2 to the image processing apparatus 2a (process P64).

Upon receiving the answer D2, the image processing apparatus 2a grasps the operation state of the image processing apparatus 2c, based on the answer D2. When grasping that the image processing apparatus 2c is executing the job, the image processing apparatus 2a specifies a component operating in the image processing apparatus 2c and refers to the failure prediction list 53, thereby judging the component rank 53c of the component (process P65). As a result, when it is judged that the component rank 53c is higher than the predetermined rank, the image processing apparatus 2a judges a possibility of failure of the component (process P66). In a case where there is a possibility that the component operating in the other image processing apparatus 2c fails at the end of the execution of the job, the image processing apparatus 2a judges a transmission time required from the start to the completion of the transmission of the data 57 to the server 5 (process P67). Then, the image processing apparatus 2a compares the transmission time with the predicted end time of the job, and decides to perform the data transmission at the current transmission timing in a case where it is possible to complete the data transmission to the server 5 from the image processing apparatus 2 before the execution of the job in the other image processing apparatus 2c ends (process P68). Based on this decision, the image processing apparatus 2a transmits the data 57 to the server 5 (process P69).

When the data transmission from the image processing apparatus 2a to the server 5 is completed, the other image processing apparatus 2c ends the execution of the job (process P70). At this time, if the component fails in the other image processing apparatus 2c and an abnormality occurs, data transmission is performed from the other image processing apparatus 2c to the server 5.

By adopting the operation example as described above, it is possible to prevent as much as possible occurrence of a state in which the plurality of image processing apparatuses 2 simultaneously performs data transmission to the server 5. For that reason, it is possible to suppress an increase in the load on the server 5.

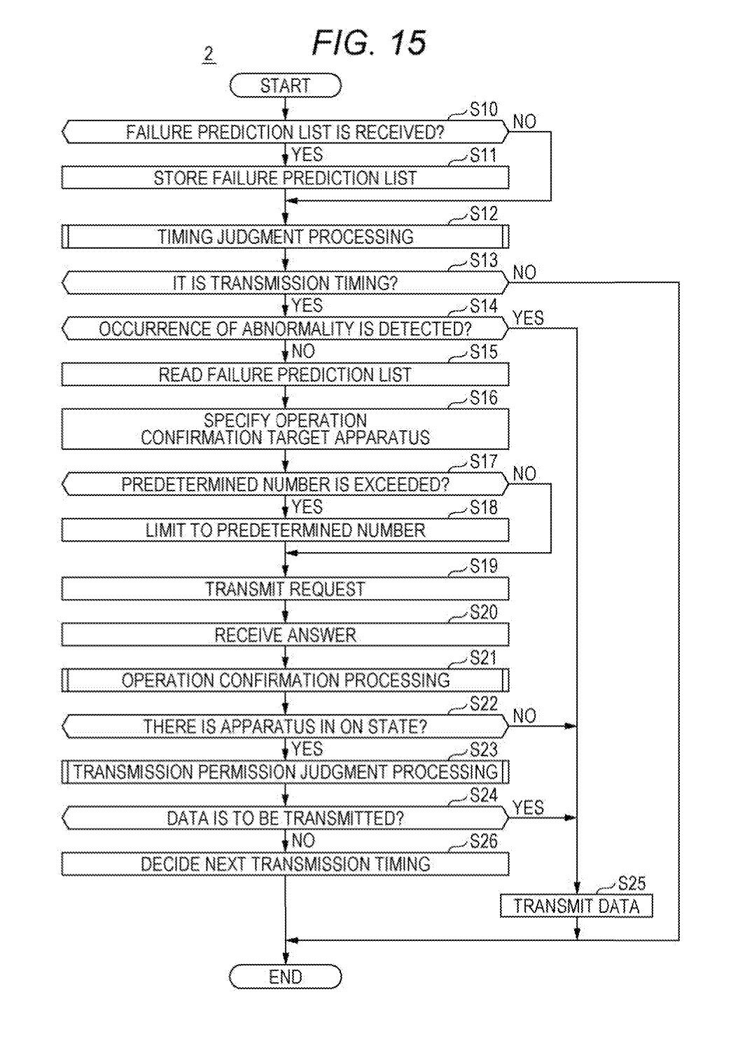

Next, an example will be described of an operation procedure performed in the image processing apparatus 2. FIGS. 15 to 18 are flowcharts illustrating an example of a processing procedure performed in the image processing apparatus 2. This processing is performed, for example, by the CPU 50a of the image processing apparatus 2 executing the program 52, and is repeatedly executed at predetermined time intervals in the image processing apparatus 2.

Upon starting this processing, the image processing apparatus 2 first determines whether or not the failure prediction list 53 is received from the server 5 (step S10). In a case where the failure prediction list 53 is received (YES in step S10), the image processing apparatus 2 stores the failure prediction list 53 received in the storage device 51 (step S11). Note that, in a case where the failure prediction list 53 is not received (NO in step S10), the processing of step S11 is skipped.

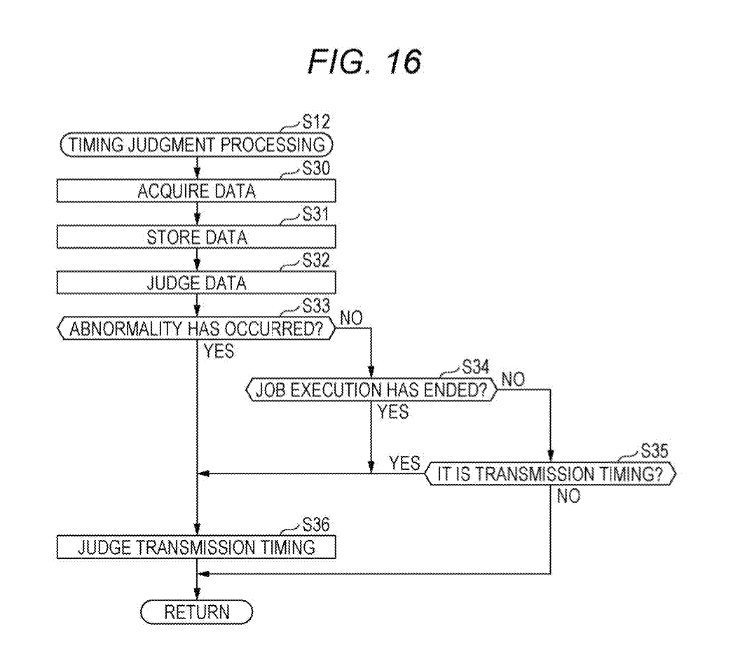

Next, the image processing apparatus 2 performs timing judgment processing (step S12). FIG. 16 is a flowchart illustrating an example of a detailed processing procedure of the timing judgment processing (step S12). As illustrated in FIG. 16, upon starting the timing judgment processing, the image processing apparatus 2 acquires the sensor data 55 and the counter data 56 from the inside of the apparatus main body (step S30), and stores those data in the storage device 51 (step S31). Then, the image processing apparatus 2 judges the data 57 including the log data 54, the sensor data 55, and the counter data 56 stored in the storage device 51 (step S32), and determines whether or not an abnormality has occurred in components inside the apparatus (step S33). When no abnormality has occurred (NO in step S33), the image processing apparatus 2 determines whether or not it is the timing at which the execution of the job has ended (step S34). In a case where it is not the timing at which the execution of the job has ended (NO in step S34), the image processing apparatus 2 determines whether or not it is the timing at which the data transmission is to be performed to the server 5 (step S35). The timing at which the data transmission is to be performed includes not only the timing at which the regular transmission is to be performed to the server 5 but also the next transmission timing decided by the timing judgment unit 65 in a case where the data transmission is not performed to the server 5. As a result, in a case where it is not the timing at Which the data transmission is to be performed to the server 5 (NO in step S35), the image processing apparatus 2 judges that the current timing is not the timing at which the data transmission is to be performed, and ends the timing judgment processing (step S12).

On the other hand, in a case where the occurrence of the abnormality is detected (YES in step S33), in a case where it is the timing at which the execution of the job has ended (YES in step S34), or in a case where it is the timing at which the data transmission is to be performed to the server 5 (YES in step S35), the image processing apparatus 2 judges that the current timing is the transmission timing at which the data transmission is to be performed to the server 5 (step S36). Thus, the timing judgment processing (step S12) ends.

Referring back to FIG. 15, when the timing judgment processing (step S12) ends, the image processing apparatus 2 determines whether or not it is judged that it is the transmission timing (step S13). As a result, in a case Where it is not judged that it is the transmission timing (NO in step S13), the processing by the image processing apparatus 2 ends.

On the other hand, in a case where it is judged that it is the transmission timing (YES in step S13), the image processing apparatus 2 determines whether or not the occurrence of the abnormality is detected (step S14). In a case where the occurrence of the abnormality is not detected (NO in step S14), the image processing apparatus 2 reads the failure prediction list 53 (step S15), and specifies as the operation confirmation target the other image processing apparatus 2 whose rank is higher than that of the image processing apparatus 2 (step S16). When all the image processing apparatuses 2 whose ranks are higher than the rank of the image processing apparatus 2 are specified as the operation confirmation targets, next, the image processing apparatus 2 determines whether or not the number of the other image processing apparatuses 2 specified as the operation confirmation targets exceeds a predetermined number (step S17). As a result, in a case where the number of the other image processing apparatuses 2 that are operation confirmation targets exceeds the predetermined number (YES in step S17), the image processing apparatus 2, for example, raises one by one the rank of the image processing apparatus 2 specified as the operation confirmation target, thereby limiting the number of the other image processing apparatuses 2 that are the operation confirmation targets to the predetermined number (step S18). For example, the image processing apparatus 2 limits the number of the other image processing apparatuses 2 that are the operation confirmation targets to about 10, thereby being able to avoid that it takes a lot of time for operation conformation. Note that, in a case where the number of the other image processing apparatuses 2 that are the operation confirmation targets does not exceed the predetermined number (NO in step S17), the processing of step S18 is skipped.

Next, the image processing apparatus 2 transmits the request D1 for performing operation confirmation to each of the other image processing apparatuses 2 that are the operation confirmation targets (step S19), and receives the answer D2 from each of the other image processing apparatuses 2 (step S20). Upon receiving the answer D2, the image processing apparatus 2 executes operation confirmation processing (step S21).

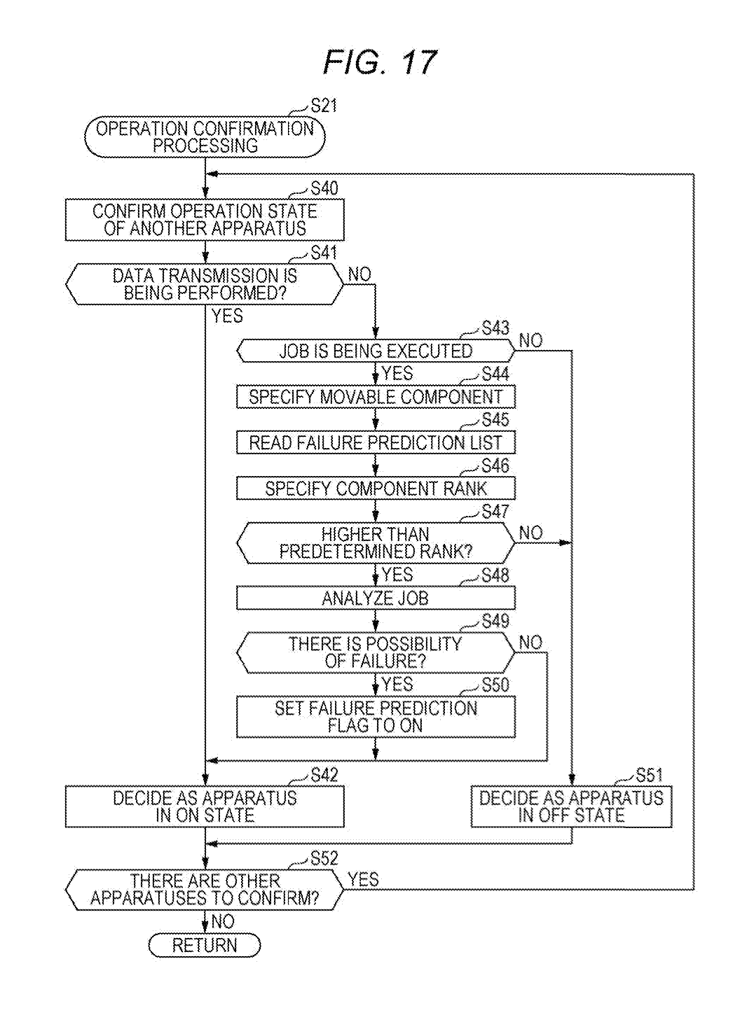

FIG. 17 is a flowchart illustrating an example of a detailed processing procedure of the operation confirmation processing (step S21). Upon starting the operation confirmation processing (step S21), the image processing apparatus 2 first focuses on one of the plurality of image processing apparatuses 2 specified as the operation confirmation targets. Then, based on the answer D2 received from the other image processing apparatus 2 focused, the image processing apparatus 2 confirms an operation state of the other image processing apparatus 2 (step S40). Then, the image processing apparatus 2 determines whether or not the other image processing apparatus 2 focused is in a state of performing the data transmission to the server 5 (step S41). In a case where the other image processing apparatus 2 is performing the data transmission (YES in step S41), the image processing apparatus 2 specifies the other image processing apparatus 2 focused as an apparatus in the ON state (step S42).

On the other hand, in a case where the other image processing apparatus 2 focused is not performing data. transmission (NO in step S41), next, the image processing apparatus 2 determines whether or not the other image processing apparatus 2 focused is executing a job (step S43). In a case where the other image processing apparatus 2 is executing the job (YES in step S13), the image processing apparatus 2 specifies a movable component operating the other image processing apparatus 2 (step S44). The image processing apparatus 2 reads the failure prediction list 53 (step S45), and specifies the component rank 53c of the movable component operating in the other image processing apparatus 2 (step S46). Then, the image processing apparatus 2 determines whether or not the component rank 53c of the movable component operating in the other image processing apparatus 2 is higher than the predetermined rank (step S47). As a result, in a case where the component rank 53c is higher than the predetermined rank (YES in step S47), the image processing apparatus 2 analyzes the job being executed in the other image processing apparatus 2 (step S48), and determines whether or not there is a possibility of failure at the end of the execution of the job (step S49). As a result, in a case where it is determined that there is the possibility of failure (YES in step S49), the image processing apparatus 2 sets a failure prediction flag to ON (step S50). Note that, in a case where there is no possibility of failure at the end of the execution of the job (NO in step S49), the processing of step S50 is skipped. Then, the image processing apparatus 2 specifies the other image processing apparatus 2 focused as an apparatus in the ON state (step S42).

On the other hand, in a case where the other image processing apparatus 2 focused is not executing the job (NO in step S43), or in a case where the component rank 53c of the movable component operating in the other image processing apparatus 2 is not higher than the predetermined rank (NO in step S47), the image processing apparatus 2 specifies the other image processing apparatus 2 focused as an apparatus in the OFF state (step S51).

Thereafter, the image processing apparatus 2 determines whether or not discrimination has been performed whether the image processing apparatus 2 is in the ON state or the OFF state, for all of the plurality of image processing apparatuses 2 specified as the operation confirmation targets (step S52). As a result, in a case where there is the other image processing apparatus 2 that has not vet discriminated whether it is in the ON state (YES in step S52), the processing by the image processing apparatus 2 returns to step S40, and the processing described above is repeated. On the other hand, in a case where discrimination processing whether the image processing apparatus 2 is in the ON state or the OFF state has ended for all of the plurality of image processing apparatuses 2 specified as the operation confirmation targets (NO in step S52), the operation confirmation processing (step S21) ends.

Referring back to FIG. 15, when the operation confirmation processing (step S21) ends, the image processing apparatus 2 determines whether or not there is an apparatus in the ON state among the other image processing apparatuses 2 specified as the operation confirmation targets (step S22). Here, if at least one apparatus is in the ON state, it is determined as YES. In a case where there is the apparatus in the ON state (YES in step S22), the image processing apparatus 2 executes transmission permission judgment processing (step S23).

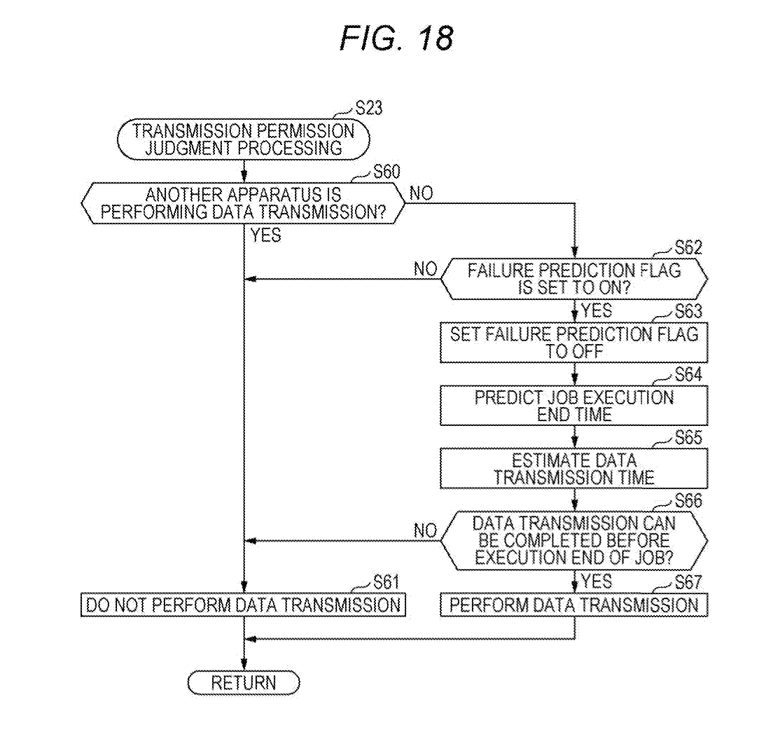

FIG. 18 is a flowchart illustrating an example of a detailed processing procedure of the transmission permission judgment processing (step S23). Upon starting the transmission permission judgment processing (step S23), the image processing apparatus 2 first determines whether or not the other image processing apparatus 2 specified as the apparatus in the ON state is performing the data transmission to the server 5 (step S60). In a case where the other image processing apparatus 2 is performing the data transmission (YES in step S60), the image processing apparatus 2 decides not to transmit data at the current transmission timing (step S61).

On the other hand, in a case where the other image processing apparatus 2 specified as the apparatus in the ON state is not performing the data transmission (NO in step S60), the image processing apparatus 2 determines whether or not the failure prediction flag is set to ON (step S62). In a case where the failure prediction flag is set to OFF (NO in step S62), the image processing apparatus 2 decides not to perform the data transmission at the current transmission timing (step S61).

In a case where the failure prediction flag is set to ON (YES in step S62), the image processing apparatus 2 sets the failure prediction flag to OFF (step S63). Then, the image processing apparatus 2 predicts an execution end time of the job being executed in the other image processing apparatus 2 (step S64), and estimates a data transmission time in a case where the image processing apparatus 2 performs data transmission to the server 5 (step S65). Then, the image processing apparatus 2 determines whether or not the data transmission of the image processing apparatus 2 can be completed before the execution of the job ends in the other image processing apparatus 2 (step S66). As a result, in a case Where the data transmission of the image processing apparatus 2 cannot be completed before the execution of the job ends in the other image processing apparatus 2 (NO in step S66), the image processing apparatus 2 decides not to perform the data transmission at the current transmission timing (step S61). On the other hand, in a case where the data transmission of the image processing apparatus 2 can be completed before the execution of the job ends in the other image processing apparatus 2 (YES in step S66), the image processing apparatus 2 decide to perform the data transmission at the current transmission timing (step S67). Even when the other image processing apparatus 2 is in the ON state, in a case where a predetermined condition is satisfied, the image processing apparatus 2 may therefore decide to perform the data transmission at the current transmission timing. Thus, the transmission permission judgment processing (step S23) ends.

Referring back to FIG. 15 again, when the transmission permission judgment processing (step S23) ends, the image processing apparatus 2 determines whether or not it is decided to transmit the data 57 to the server 5 (step S24). In a case where it is decided to transmit the data 57 (YES in step S24), the image processing apparatus 2 transmits the data 57 to the server 5 (step S25). In this case, the image processing apparatus 2 can complete the data transmission to the server 5 before the job execution ends in the other image processing apparatus 2.

In a case where the occurrence of the abnormality is detected when it is judged that it is the transmission timing (YES in step S14), the image processing apparatus 2 transmits the data 57 to the server 5 (step S25). In this case, the image processing apparatus 2 starts the data transmission to the server 5 without confirming the operation state of the other image processing apparatuses 2. When the abnormality occurs in the component or the like, the job cannot be executed in the image processing apparatus 2, so that the data 57 at the time of the occurrence of the abnormality is data with the highest degree of urgency. For that reason, the image processing apparatus 2 promptly transmits the data 57 with high degree of urgency to the server 5 without confirming the operation state of the other image processing apparatuses 2. However, when the image processing apparatus 2 performs the data transmission without confirming the operation state of the other image processing apparatus 2, there is a possibility that a situation occurs in which the data transmission is performed to the server 5 simultaneously with the other image processing apparatuses 2. To prevent this, the data 57 may be transmitted to the server 5 after confirming only that the other image processing apparatus 2 is not performing the data transmission to the server 5.

In a case where there is no apparatus in the ON state among the other image processing apparatuses 2 specified as the operation confirmation targets (NO in step S22), the image processing apparatus 2 transmits the data 57 to the server 5 (step S25). In this case, since there is no possibility that the data transmission is performed from the other image processing apparatus 2 to the server 5, the image processing apparatus 2 can efficiently transmit the data 57 without increasing the load on the server 5.

In a case where it is decided not to perform the data transmission to the server 5 at the current transmission timing (NO in step S24), the image processing apparatus 2 decides the next transmission timing (step S26). That is, the image processing apparatus 2 decides as the next transmission timing a timing at which a predetermined time such as five minutes has elapsed after the current transmission timing. Therefore, even if the data transmission to the server 5 is not performed at the current transmission timing, the next transmission timing is reached when the predetermined time has elapsed, and it becomes possible to perform the data transmission to the server 5.

The image processing apparatus 2 performs the processing as described above, thereby being able to reduce the possibility that the data transmission is performed simultaneously with the other image processing apparatuses 2 when transmitting the data 57 to the server 5 at the transmission tinting at which the data transmission is performed to the server 5. For that reason, it is possible to suppress that the data transmission concentrates in the server 5 at a time, and it becomes possible to reduce the load on the server 5.

In particular, the image processing apparatus 2 acquires and stores from the server 5 the failure prediction list 53 in which the plurality of image processing apparatuses 2 is ranked in order from the one whose possibility of failure is higher, or in order from the one whose replacement time of the component is closer, and when detecting that it is the transmission timing, refers to the failure prediction list 53 and confirms the operation state of the other image processing apparatus 2 whose rank is the same as or higher than that of the image processing apparatus 2, and transmits the data 57 to the server 5 after confirming that no data transmission is performed from the other image processing apparatus 2. For that reason, the image processing apparatus 2 can transmit the data 57 to the server 5 in a state in Which no data transmission is performed from the other image processing apparatus 2 Whose rank is the same as or higher than that of the image processing apparatus 2, and can efficiently perform the data transmission without increasing the load on the server 5.

If the image processing apparatus 2 starts the data transmission to the server 5 without confirming the operation state of the other image processing apparatus 2 whose rank is lower than that of the image processing apparatus 2, there is a possibility that a large load is temporarily applied to the server 5 when the other image processing apparatus 2 whose rank is lower than that of the image processing apparatus 2 has already started performing the data transmission. To prevent this, in a case where it is detected that it is the transmission timing, the image processing apparatus 2 may, for example, further confirm that the other image processing apparatus 2 whose rank is lower than that of the image processing apparatus 2 is not performing the data transmission to the server 5. In this case, it is sufficient that the image processing apparatus 2 decides to transmit the data 57 to the server 5 on an additional condition that the other image processing apparatus 2 whose rank is lower than that of the image processing apparatus 2 is not performing the data transmission to the server 5.

The embodiment related to the present invention has been described above; however, the present invention is not limited to the contents described in the above embodiment, and various modifications are applicable.

For example, when the data transmission unit 68 transmits the data 57 to the server 5, only data varying from the data 57 transmitted last time may be extracted and transmitted to the server 5.

In the above embodiment, a case has been exemplified where the image processing apparatus 2 includes the MFP, and has the plurality of functions such as the scan function, the print function, and the copy function. However, the image processing apparatus 2 is not necessarily limited to the one having the plurality of functions such as the scan function, the print function, and the copy function. For example, the image processing apparatus 2 may be a scanner having only the scanning function, or a printer having only the print function. The image processing apparatus 2 may be provided with image processing functions other than the scan function and the print function.

In the above embodiment, a case has been exemplified where the program 52 executed by the CPU 50a, is installed in advance in the image processing apparatus 2. However, the program 52 is not limited to the one installed in advance in the image processing apparatus 2, and may be a target of transactions alone. In that case, the program 52 may be provided to the image processing apparatus 2 in a form of being downloaded by the user oneself via the Internet or the like, or may be provided to the image processing apparatus 2 in a state of being recorded in a computer-readable recording medium such as a CD-ROM or a USB memory. The same applies to the program 59 stored in the server 5.

Although embodiments of the present invention have been described and illustrated in detail, the disclosed embodiments are made for purposes of illustration and example only and not limitation. The scope of the present invention should be interpreted by terms of the appended claims.

What is claimed is:

1. An image processing apparatus that transmits data relating to an internal component to a server via a network, the image processing apparatus comprising
a hardware processor that:
acquires the data relating to the internal component;
judges whether or not it is a transmission timing at which the data acquired is to be transmitted to the server;
confirms an operation state of another image processing apparatus connected to the network in a case where it is judged that it is the transmission timing;
decides whether or not to transmit the data acquired to the server based on a confirmation result; and
transmits the data acquired to the server in a case where it is decided to perform data transmission.

2. The image processing apparatus according to claim 1, where the data relating to the internal component includes data that varies with execution of a job.

3. The image processing apparatus according to claim 1, wherein the data relating to the internal component includes at least one of sensor data output from a sensor that monitors an operation state of the internal component, counter data to be incremented, with execution of a job, or log data indicating an execution history of the job.

4. The image processing apparatus according to claim 1, wherein the hardware processor judges that it is the transmission timing when detecting any one of an occurrence of an abnormality, a job execution end, or a regular transmission time arrival.

5. The image processing apparatus according to claim 4, wherein the hardware processor decides to transmit the data acquired to the server in a case where it is judged that it is the transmission timing due to detection of the occurrence of the abnormality.

6. The image processing apparatus according to claim 1, wherein
the hardware processor determines that another image processing apparatus is in an ON state in a case where a movable component is in a state of being operated in the other image processing apparatus or the other image processing apparatus is in a state of performing data transmission to the server, and
the hardware processor decides to transmit the data acquired to the server in a case where it is determined that the other image processing apparatus is not in the ON state.

7. The image processing apparatus according to claim 6, wherein the hardware processor decides to transmit the data acquired to the server in a case where it is determined that all of two or more other image processing apparatuses are not in the ON state.

8. The image processing apparatus according to claim 6, wherein the hardware processor decides not to perform data transmission to the server at the transmission timing judged in a case where it is determined that another image processing apparatus is in the ON state.

9. The image processing apparatus according to claim 8, wherein the hardware processor decides a next transmission timing in a case where it is decided not to perform data transmission.

10. The image processing apparatus according to claim 1, wherein
the hardware processor acquires from the server a failure prediction list in which a plurality of image processing apparatuses connected to the network is ranked, and
the hardware processor specifies another image processing apparatus whose operation state is to be confirmed from among the plurality of image processing apparatuses by referring to the failure prediction list, and confirms the operation state of the other image processing apparatus specified.

11. The image processing apparatus according to claim 10, wherein the failure prediction list includes a component rank indicating ease of failure of individual components mounted in each of the plurality of image processing apparatuses, and an overall rank of an entire apparatus.

12. The image processing apparatus according to claim 11, wherein the component rank is a rank decided depending on a degree of arrival at a replacement time of a component.

13. The image processing apparatus according to claim 11, wherein the component rank is a rank decided depending on a number of times of abnormality occurrence of a component.

14. The image processing apparatus according to claim 11, wherein the overall rank is a rank decided based on the component rank.

15. The image processing apparatus according to claim 10, wherein the hardware processor specifies another image processing apparatus whose rank is higher than that of the image processing apparatus in the failure prediction list among the plurality of image processing apparatuses, as the other image processing apparatus whose operation state is to be confirmed.

16. The image processing apparatus according to claim 10, wherein the hardware processor limits a number of the image processing apparatuses to a predetermined number or less, the image processing apparatuses each being specified as the other image processing apparatus whose operation state is to be confirmed from among the plurality of image processing apparatuses.

17. The image processing apparatus according to claim 10, wherein in a case where a movable component is in operation in the other image processing apparatus specified, the hardware processor determines whether or not a component rank of the movable component is higher than a predetermined rank, and determines that the other image processing apparatus is not in an ON state when the component rank of the movable component is lower than the predetermined rank.

18. The image processing apparatus according to claim 10, wherein
in a case where a movable component is in operation in the other image processing apparatus specified, the hardware processor determines whether or not a component rank of the movable component is higher than a predetermined rank, and further determines whether or not there is a possibility that the movable component fails during the operation or at an end of the operation of the movable component when the component rank of the movable component is higher than the predetermined rank, and
in a case where it is determined that there is the possibility that the movable component fails during the operation or at the end of the operation of the movable component, the hardware processor decides to perform data transmission to the server after the other image processing apparatus specified completes data transmission.

19. The image processing apparatus according to claim 10, wherein
in a case where a movable component is in operation in the other image processing apparatus specified, the hardware processor determines whether or not a component rank of the movable component is higher than a predetermined rank, and further determines whether or not there is a possibility that the movable component fails at an end of the operation when the component rank of the movable component is higher than the predetermined rank, and
when it is determined that there is the possibility that the movable component fails at the end of the operation, the hardware processor decides to perform data transmission to the server on condition that it is possible to end the data transmission to the server before the operation of the movable component ends.

20. A non-transitory recording medium storing a computer readable program executed in an image processing apparatus that transmits data, relating to an internal component to a server via a network, the computer readable program causing the image processing apparatus to perform:
acquiring the data relating to the internal component;
judging whether or not it is a transmission timing at which the data acquired by the acquiring is to be transmitted to the server:
confirming an operation state of another image processing apparatus connected to the network in a case where it is judged by the judging that it is the transmission timing;
deciding whether or not to transmit the data acquired by the acquiring to the server based on a confirmation result by the confirming; and
transmitting the data acquired by the acquiring to the server in a case Where it is decided by the deciding to perform data transmission.
